(19) United States
(12) Patent Application Publication
(10) Pub. No.: US 2026/0127663 A1
(43) Pub. Date: May 7, 2026

(54) HOMOMORPHIC ENCRYPTION FOR ONLINE BIDDING

(71) Applicant: Zoho Corporation Private Limited, Kanchipuram District (IN)

(72) Inventors: Naveen Seenivasagam, Chennai (IN); Panimalar Aravindan, Chennai (IN); Nandini Malhotra, Hyderabad (IN); Keerthana Sethuraman Mallika, Chennai (IN); Ramprakash Ramamoorthy, Singaperumal Koil (IN); Shailesh Kumar Davey, Kanchipuram District (IN)

(73) Assignee: Zoho Corporation Private Limited, Kanchipuram District (IN)

(21) Appl. No.: 19/379,828

(22) Filed: Nov. 5, 2025

Related U.S. Application Data
(60) Provisional application No. 63/735,447, filed on Dec. 18, 2024.

(30) Foreign Application Priority Data
Nov. 6, 2024 (IN) 202441085173

(51) Int. Cl. G06Q 30/08; H04L 9/00

(52) U.S. Cl. CPC G06Q 30/08; H04L 9/008; G06Q 2220/00

(57) ABSTRACT

Encrypted bids from a group of users responsive to a bidding process request for bids, such as an auction or tender, are modified homomorphically to select a winning bid and identify a winner bidder (or multiple winning bidders) in an online bidding system. The encrypted results can be validated homomorphically prior to the bid selection and bidder identification. Validation can comprise nullifying bids with values outside the bidding specification, or those tendered in an inappropriate format. Validation may comprise masking a vectored bid response to nullify any non-compliant values in invalid positions in the vector, while allowing the compliant value or values to remain. Multi-bid vectors are supported. Validation can support reserve bidding by eliminating bids that are below a specified minimum (e.g. in an auction) or above a specified maximum (e.g. in a tender). The modified bids can optionally be anonymized to remove any indication about the pre-modification bid value.

### FIELD OF THE INVENTION

Embodiments of the present disclosure are related, in general, to online bidding and more particularly, but not exclusively, to homomorphic bid selection from and validation of encrypted bids.

### CROSS REFERENCE TO RELATED APPLICATIONS

This application is related to Indian Provisional Application 202441085173, filed 6 Nov. 2024, and U.S. Provisional Application 63/735,447, filed 18 Dec. 2024, entitled “HOMOMORPHIC ENCRYPTION FOR ONLINE BIDDING”, both of which are incorporated herein by reference.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 depicts homomorphic bidding system 100.

FIG. 2 is a flowchart 200 illustrating bidding, bid selection, and bidder identification in an example embodiment.

FIG. 3 illustrates example bids and bidder identifications encoded into vectors in preparation for encryption.

FIG. 4 shows an example scheme 400 for encryption, decryption, and homomorphic computing useful for performing validation and analysis of encrypted bids.

FIG. 5 identifies various homomorphic operations which may be used for manipulating encrypted bids for validation, bid selection, and bidder identification.

FIG. 6 is a flowchart 600 illustrating a process for homomorphic bid selection and bidder identification for a bidding process seeking the highest or maximum bid, such as an auction.

FIG. 7 is a flowchart 700 illustrating a process for homomorphic bid selection and bidder identification for a bidding process seeking the lowest or minimum bid, such as a tender.

FIG. 8 illustrates results of a bidding process seeking a maximum bid with no validation.

FIG. 9 illustrates results of a bidding process seeking a minimum bid with no validation.

FIG. 10 is a flowchart 1000 illustrating a process for validating a bid, referred to as validation option 1.

FIG. 11 is a flowchart 1100 illustrating another process for validating a bid, referred to as validation option 2.

FIG. 12 illustrates the results of applying validation option 1 to the example bids detailed in FIG. 3.

FIG. 13 illustrates the results of applying validation option 2 to the example bids detailed in FIG. 3.

FIG. 14 illustrates results of a bidding process seeking a maximum bid using the bids validated using option 1.

FIG. 15 illustrates results of a bidding process seeking a maximum bid using the bids validated using option 2.

FIGS. 16 and 17 illustrate results for bidding processes seeking a minimum bid using the bids validated using options 1 and 2, respectively.

FIG. 18 is a flowchart 1800 illustrating a bid validation process for removing zeros.

FIGS. 19A and 19B are flowcharts 1900 and 1950 illustrating anonymizing processes.

FIG. 20 shows the results of minimum bid selection and bidder identification after zero substitution as well as the benefits of optional bid anonymization.

FIG. 21 is a flowchart 2100 illustrating validation of bids in a bidding process seeking a maximum bid and supporting a minimum reserve value.

FIG. 22 illustrates results for an example seeking a maximum bid with a minimum reserve value of 5.

FIG. 23 illustrates results for an example seeking a maximum bid with a minimum reserve value of 10.

FIG. 24 is a flowchart 2400 illustrating validating bids for a bidding process seeking a minimum bid with a maximum reserve value.

FIG. 25 illustrates results for an example seeking a minimum bid with a maximum reserve value of 4.

FIG. 26 illustrates example multi-bid results with differing reserve values.

FIG. 27 is an example bidding system 2700.

FIG. 28 illustrates a process flow 2800 for bidding system 2700.

FIG. 29 is a flowchart 2900 illustrating an example bidding creation process.

FIG. 30 is a flowchart 3000 illustrating a process for online bidding by a user.

FIG. 31 (prior art) depicts a general-purpose computing system 3100 that can serve as a client or a server depending on the program modules and components included.

### DETAILED DESCRIPTION

Online auction systems exist to facilitate distributed, convenient, safe, and secure bidding access to a population of bidders participating in an auction or a tender. A bidding system should provide for secure and accurate bids from identity-authenticated users who are authorized to participate in a particular auction. Bid analysis should be performed on responses that have been validated, to provide accurate and untampered results. The winner of any bidding process should be identifiable, and the winning bid recorded accurately. Additionally, in some bidding systems, it will be desirable to provide privacy and/or anonymity to users or bidders participating in an auction or tender.

Encrypted bids from a group of users responsive to a bidding process request for bids, such as an auction or tender, are modified homomorphically to select a winning bid and identify a winner bidder (or multiple winning bidders) in an online bidding system. The encrypted results can be validated homomorphically prior to the bid selection and bidder identification. Validation can comprise nullifying bids with values outside the bidding specification, or those tendered in an inappropriate format. Validation may comprise masking a vectored bid response to nullify any non-compliant values in invalid positions in the vector, while allowing the compliant value or values to remain. Validation can support reserve bidding by eliminating bids that are below a specified minimum (e.g. in an auction) or above a specified maximum (e.g. in a tender). The modified bids can optionally be anonymized to remove any indication about the pre-modification bid value (e.g. to keep the non-winning bid values confidential).

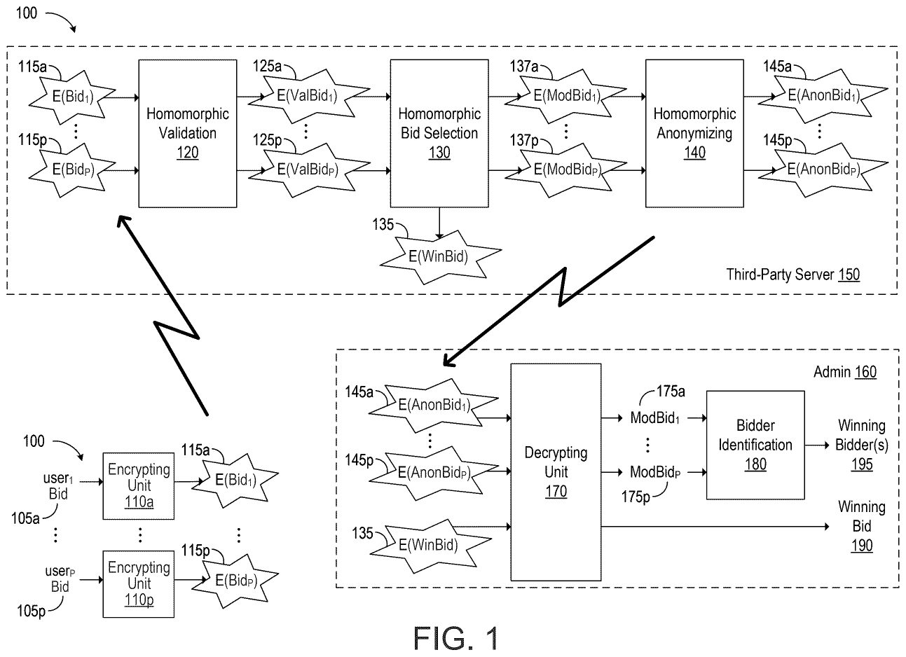

FIG. 1 depicts homomorphic bidding system 100. A group of P users, user₁ to userₚ, respond to a bidding program, and the bids 105a to 105p are encrypted in encrypting units 110a to 110p to produce encrypted bids 115a to 115p, E(Bid₁) to E(Bidₚ), respectively. Homomorphic bid selection unit 130 receives a set of encrypted bids and produces an encrypted winning bid, E(WinBid) 135, and a set of modified encrypted bids 137a-p, E(ModBid₁) to E(ModBidₚ). The encrypted bids 115a-p may be supplied directly to homomorphic bid selection unit 130 when no validation is required. In FIG. 1, encrypted bids 115a-p are delivered as inputs to homomorphic validation unit 120 to produce encrypted validated bids 125a-p, E(ValBid₁) to E(ValBidₚ), respectively, which are delivered as inputs to homomorphic bid selection unit 130.

Decrypting unit 170 receives a series of encrypted modified bids along with the encrypted winning bid E(WinBid) 135 and decrypts them to reveal the decrypted modified bids 175a-175p, ModBid₁ to ModBid_{P}, respectively, along with the winning bid 190. The encrypted modified bids 137a-p may be supplied directly to decrypting unit 170. In FIG. 1, encrypted modified bids 137a-p are delivered as inputs to homomorphic anonymizing unit 140 to produce encrypted anonymized modified bids 145a-p, E(AnonBid₁) to E(AnonBidₚ), respectively, which are delivered as inputs to decrypting unit 170. Bidder identification unit 180 analyzes the modified bids to identify a winning bidder or winning bidders 195 (optionally conditioned on prerequisites for a winning bid being satisfied).

The encrypted bids are modified using homomorphic computation, meaning the computation is carried out on encrypted values without decrypting, any intermediate values remain encrypted, and any results (137 or 145) are delivered encrypted as well. In the example embodiment, features desirable in an online bidding system such as integrity of the bid selection process, confidentiality of bid information, and protection of bidder identity (if desired) are facilitated by segregating various processes into separate entities or units. In this example, an administrator, admin 160, is responsible for producing public keys for use by users to encrypt their bids. Admin 160 retains all private keys which means decrypting can be limited to within that entity or organization. Processing of the encrypted bids occurs in a third-party server 150, which only operates on encrypted values, and has no access to the keys required to decrypt those values. Third-party server 150 includes homomorphic bid selection 130 and optionally homomorphic validation 120 and anonymizing 140, as desired. In the figures herein, a star outline in a block diagram indicates ciphertext (or ciphertext computations), and E(X) represents an encryption such that it, if decrypted, would yield X.

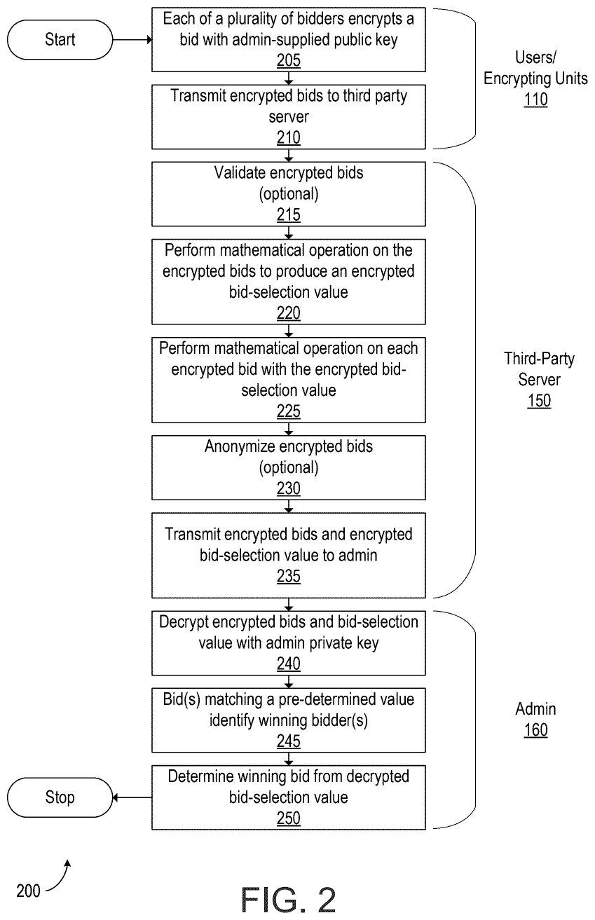

FIG. 2 is a flowchart 200 illustrating bidding, bid selection, and bidder identification in an example embodiment. Each of a plurality of bidders, having been given access to an encryption key from admin 160, encrypts the respective user bid 105 using an encrypting unit 110 (205). In the example embodiment, public key encryption is utilized, where the administrator provides a public key or keys to the bidders and retains the private key or keys from the pair for decryption.

The encrypted bids are transmitted to third-party server 150 (210). The encrypted bids are optionally validated (215). Examples of validation include eliminating negative or zero values in bids in a tendering process, removing bids that don't meet a reserve value in an auction or a tender, or correcting or nullifying bids not meeting formal requirements. A variety of validation examples are detailed further below.

A mathematical operation is performed homomorphically on the encrypted (and optionally validated) bids to produce an encrypted bid-selection value (220). A second mathematical operation is performed on each encrypted bid, homomorphically, as a function of the encrypted bid-selection value (225). In a bidding process example, the bid-selection value is determined by finding the maximum bid from the set of encrypted bids. Each of the set of encrypted bids is then modified by subtracting the bid-selection value from the bid. This and other bid-selection examples are detailed further below. In some cases, the modified bids may, upon decryption, provide an indication of the values of non-winning bids. When this is undesirable, the modified encrypted bids are anonymized (230). Then the modified encrypted bids and encrypted bid-selection value are transmitted to the administrator, admin 160 in this example.

The administrator uses the private key or keys to decrypt the modified bids and the bid-selection value (240). One or more bids that match a predetermined value identify one or more winning bidders (245). The winning bid is determined from the decrypted bid-selection value (250). In the illustration just given, the bid-selection value is the maximum bid and therefore the winning bid. The winning bidder is identified as the bidder associated with a modified bid matching the predetermined value of zero, resultant from the subtraction operation 225. In alternate embodiments, additional or alternate computation on the modified bids may establish an alternate predetermined value for identifying winning bids. If more than one bidder bid the same maximum bid, then more than one modified bid will have a zero value, and multiple winners can be identified (an additional process to decide between tied bidders may be deployed, e.g. having a second bidding process between the two winning bidders).

There are a variety of ways of associating modified bids with bidders, in order to identify bidders whose modified bids are selected as winners. A bidder ID, either plaintext or encrypted, can be associated with each bid. Alternately, the modified bids may be provided as a set in a certain order. A bidder list can be made available (encrypted or plaintext) with the same order. A winning bid, or bids, can be matched with a bidder, or bidders, based on the corresponding location in the order.

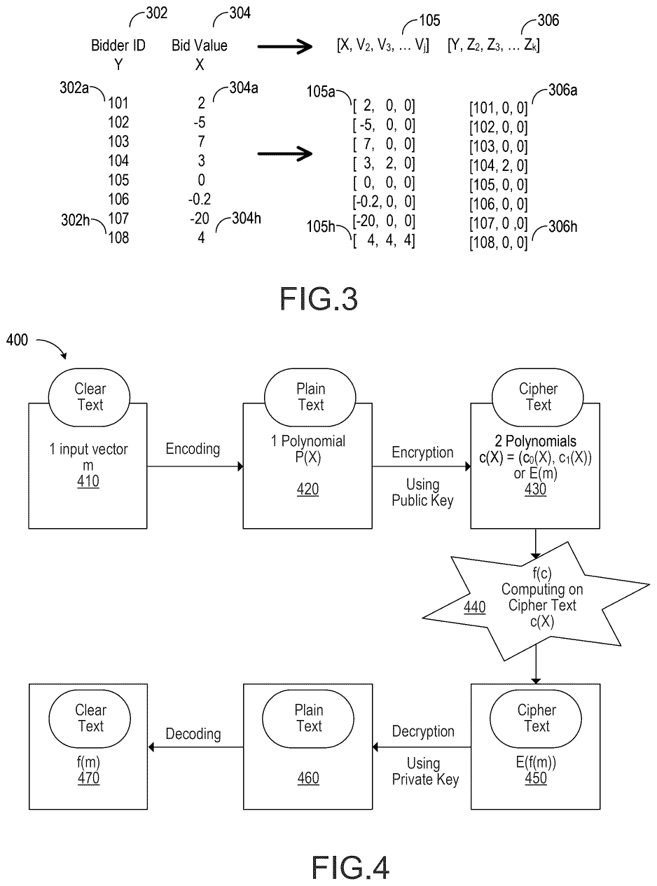

FIG. 3 illustrates example bids and bidder identifications encoded into vectors in preparation for encryption. A bid value X 304 is padded with values V₂ . . . Vⱼ to form user bid 105, a vector of size j. A bidder ID value Y 302 is padded with values Z₂ . . . Zₖ to form bidder ID 306, a vector of size k. In one embodiment, the values of X and Y are placed in the first position, and the padding values V and Z are zeros. Alternate embodiments may have X and Y placed in any position, and use any value for padding, including a stream of random numbers. Furthermore, multi-bid vectors can be supported, where multiple bids are included in multiple positions within the bid vector. Various techniques detailed herein for validating and/or masking can be applied to embodiments supporting multi-bid vectors. While this embodiment uses vectors for bids and bidder IDs, with polynomial encoding, alternate embodiments may use alternate bid, bidder ID, and encoding formats. A set of bidder ID values 101-108, 302a-h, are shown with bid values 304a-h, which are formed into user bids 105a-h and bidder IDs 306a-h. These example bid pairs will be used in various illustrations below. A vector size of 3 is selected for simplicity, while in practice the vector may be much larger.

It would be common practice for software running on a user terminal to be designed to present users with an auction or tender, receive the user's bid, and encode and encrypt only valid responses. Therefore, no validation would be required. However, a user with certain skill may be able to generate an invalid bid, encode and encrypt it, and introduce it into the bidding system to produce unfair or undesirable results. Bids #102, 106, and 107 illustrate negative bids which are likely undesirable. #104 and #108 show non-conforming vector padding. Various techniques for validating bids to nullify those that are invalid and retain those that are valid is illustrated further below. Furthermore, validation can be utilized to implement reserve bidding (detailed further below), in which case a user would not know whether or not their bid met the reserve (by design).

FIG. 4 shows an example scheme 400 for encryption, decryption, and homomorphic computing useful for performing validation and analysis of encrypted bids. There are various schemes available in homomorphic encryption ranging from leveled to bootstrappable schemes. Leveled schemes limit the number of multiplications that can be performed with a predefined depth, while bootstrappable schemes reduce the noise in ciphertext on demand, so theoretically any number of operations can be performed. However, the bootstrapping process can be computationally expensive.

The example embodiment of FIG. 4 uses the CKKS (Cheon-Kim-Kim-Song) scheme. In the examples illustrated below, a leveled homomorphic mode is used. In alternate embodiments, as the application demands, bootstrapping is used. CKKS is based on an asymmetric key encryption mechanism. In addition to a public key and the private key, Galois and relinearization keys are also generated. Using the parameters polynomial degree N and coefficient modulus “q”, the secret key polynomial “s”, relinearization key, Galois key and the public key polynomial pair (a, b=−a.s+e), where “a” is a randomly generated polynomial whose coefficients are chosen from a uniform distribution and “e” is a randomly sampled error polynomial whose coefficients are chosen from Gaussian distribution, using the concept of ring learning with errors. The private key is kept secret with the owner of the key-pair generator and the public key is published to other users in the environment. The Galois and relinearization keys are used in certain homomorphic computation.

A cleartext input is an input vector 410, such as bids 105 detailed above. The vector 410 is a message m of size N/2. The cleartext input vector is encoded into a plaintext polynomial P(X) 420, with integer coefficients modulo q (i.e., of the domain Z_{q}[x]/(1+X^{N})) P(X) 420. This encoded polynomial is then encrypted into ciphertext 430 using the published public key, c=(m+b, a), in the form of a pair of ciphertexts, c(X)=c₀(X),c₁(X). The use of the terminology cleartext and plaintext identifies the difference between text-based data and encoded text-based data, respectively. In a broader sense, both terms identify non-encrypted data, in contrast to encrypted data, or ciphertext. When the distinction between encoded or nonencoded data is not necessary, the terms plaintext and cleartext can be, and often are, used interchangeably.

The ciphertext can be subjected to a variety of mathematical computations 440. For example, consider a function f(m). The same function includes any number of homomorphic operations on the ciphertext to produce f(c), which is an encryption of f(m). The function f is applied on the ciphertext, and the result f(c) is computed homomorphically.

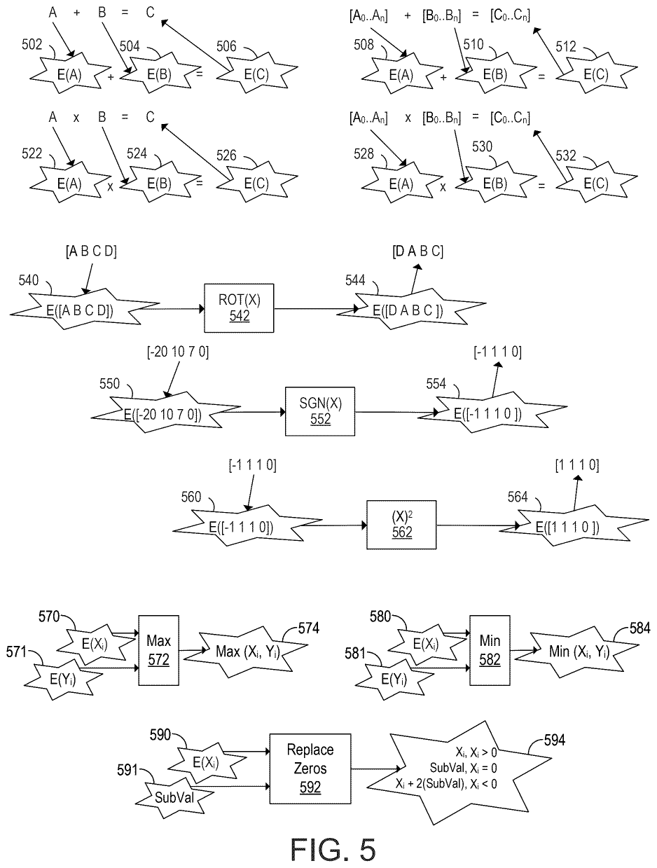

FIG. 5 identifies example homomorphic operations suitable for operating on E(m) to produce f(c), which is also represented as E(f(m)). In an example embodiment, operations are combined for manipulating encrypted bids for validation, bid selection, and bidder identification. The computations are carried out by a processing device performing a mathematical operation on the encrypted data corresponding to an operation that, when applied to plaintext data, produces the desired result. That desired result may be to change, normalize, or nullify the bid result. Their use is detailed in various embodiments below.

Homomorphic addition is one operation. Consider two variables A and B, added in cleartext to form the sum C, A+B=C. With the additive homomorphic property, E(A) 502+E(B) 504 sums to E(A+B)=E(C) 506. Decrypting E(C) 506 yields the plaintext C. Similarly, in cleartext, vectors [A₀ . . . Aₙ]+[B₀ . . . Bₙ]=[C₀ . . . Cₙ]. It then follows that E(A) 508+E(B) 510=E(A+B)=E(C) 512. Decrypting E(C) yields plaintext [C₀. Cₙ]. In the CKKS example, adding two ciphertexts, c=(c0,c1) and c′=(c0′,c1′) results in sum (c0+c0′,c1+c1′). Note, the additive identity 0 in cleartext encodes to a non-zero polynomial in ciphertext, but the homomorphic properties operate such that the encrypted representation of 0 is also an additive identity in the encryption domain.

Homomorphic multiplication is another operation. When A×B=C in cleartext, then E(A) 522×E(B) 524=E(A×B)=E(C) 526. With cleartext vectors, [A₀ . . . Aₙ]×[B₀ . . . Bₙ]=[C₀ . . . Cₙ]. And so E(A) 528×E(B) 530=E(A×B)=E(C) 532, which decrypts to [C₀ . . . Cₙ]. With CKKS, multiplying two ciphertexts c=(c0,c1) and c′=(c0′,c1′) yields (c0×c′0, c0×c′1+c′0×c1, c1× c′1), which includes the desired multiplication results plus a third term. The relinearization key is used to eliminate the third term and obtain a pair of ciphertexts (c0×c′0, c1×c′1). Note that the cleartext multiplicative identity, one, encodes to a random polynomial in ciphertext, but the homomorphic properties operate such that the encrypted ciphertext of a multiplicative identity is also a multiplicative identity in the encryption domain.

Rotation of cleartext vector by one position [A B C D]yields rotated vector [D A B C]. Using homomorphic rotation function 542 on input vector E([A B C D]) 540 results in rotated encrypted vector E([D A B Cₙ]) 544. The implementation of encrypted rotation will depend on the encryption scheme deployed. If a vector is encrypted into a vector of discrete encrypted values, e.g., E([A B C D])=[E(A) E(B) E(C) E(D)], then those discrete encrypted values are accessible and can be reordered directly. CKKS allows such value-by-value encryption, as do other encryption schemes such as the ElGamal cryptosystem. CKKS also provides for batch encryption of vectors. In the exemplary embodiment, batch encryption is used, so each element is not accessible individually in the encrypted domain. As detailed further below, rotation can be useful for a variety of validating and analysis computation on such batch-encrypted vectors. In CKKS, the Galois key is used to rotate the encrypted vector values.

Signum function SGN(X) 552 operates on an encrypted vector input 550 to produce encrypted output vector 554. For each value x in the input vector, the output is replaced with sgn(x):

$$sgn ( x ) = \{ \begin{matrix}- 1 , & x < 0 \\ 0 , & x = 0 \\ 1 , & x > 0\end{matrix}$$

An illustrated encrypted input vector 550, invalid bid [−20 10 7 0], is passed through SGN(X) 552 yielding E([−1 1 1 0]) 554.

Signum can be computed for real numbers in a variety of ways, for example, |X|/X or sqrt(X)²/X. In the example embodiment, bid vectors are encoded and encrypted into a pair of polynomials, as described above. Discontinuous, non-polynomial functions such as square root and inverse aren't directly applicable in polynomial form. Instead, a polynomial approximation of the signum function is used to perform the same operations in the encrypted domain.

The Remez algorithm in the range [−1, 1] is one suitable approximation to produce the signum function for polynomials. In general, to find a polynomial approximation of a given function f(x) on an interval [a, b] where its values on a finite set of points are known, an interpolation polynomial that passes through these points is determined. To find an optimal approximate polynomial, the error between the approximated polynomial and the function is measured, which is called a minimax polynomial. Optimal approximation is found to minimize the maximum error between the function and the approximated polynomial, iteratively. In embodiments of methods detailed below, a polynomial approximation to the signum function is generated using the Remez algorithm and stored. This approximate polynomial (R) is useful in the verification process.

A squaring function (X)² 562 is useful for squaring encrypted input vector 560 to produce encrypted output vector 564. To illustrate, the vector resulting from the SGN(X) 552 process produced E([−1 1 1 0)]. When this result is fed through squaring function 562, any remaining negative values will become positive. In this illustration, the output is E([1 1 1 0]).

Max(X, Y) 572 operates on an encrypted vector inputs 570 and 571 to produce encrypted output vector 574. For each pair of values x and y in the input vectors, the output is replaced with the maximum of x and y. The following is an example formula for Max:

$$Max ( X , Y ) = \frac{X + Y + ( X - Y ) sgn ( X - Y )}{2}$$

Min(X, Y) 582 operates on an encrypted vector inputs 580 and 581 to produce encrypted output vector 584. For each pair of values x and y in the input vectors, the output is replaced with the minimum of x and y. The following is an example formula for Min:

$$Min ( X , Y ) = \frac{X + Y + ( Y - X ) sgn ( X - Y ) )}{2}$$

ReplaceZeros (X, SubVal) 592 operates on an encrypted vector input 590 to produce encrypted output vector 594. For each value x in the input vector, the output is replaced as follows:

$$ReplaceZeros ( {X}_{i} , SubVal ) = \{ \begin{matrix}{X}_{i} , & {X}_{i} > 0 \\ SubVal , & {X}_{i} = 0 \\ {X}_{i} + 2 ( SubVal ) , & {X}_{i} < 0\end{matrix}$$

This function can be implemented as follows:

$$ReplaceZeros ( {X}_{i} , SubVal ) = {X}_{i} + SubVal ( 1 - sgn ( {X}_{i} ) )$$

In the examples illustrated below, there is no need for the third result (Xᵢ+2(SubVal)), as bids are not typically negative numbers. In these cases, Xᵢ is processed to zero out any negative numbers prior to application of the ReplaceZeros function.

Returning to FIG. 4, ciphertext 450, E(f(m)), is the result of computations f(c) 440. Ciphertext 450 can be decrypted into plaintext 460 using the private key by the owner of the key-pair generator. The decrypted polynomial is then decoded into the resultant vector, in this example f(m) 470. Thus, the cleartext message m, having been encoded and encrypted into ciphertext c, is manipulated homomorphically with function f(c). As a result, the decrypted result is f(m), the original message as if it had been manipulated in cleartext.

The following examples include results showing arrays of bids in cleartext. But, as detailed below, since the operations take place on and results are delivered in ciphertext, in accordance with homomorphic principles, the illustrative examples show the results of the operations as if they were performed in cleartext on the cleartext data represented by the encrypted results. In other words, these show the results if, at any stage, the encrypted data were decrypted and decoded. However, only the possessor of the appropriate private key can decrypt, and in the example embodiments detailed below the operations performed within third-party server 150 detailed do not have such keys accessible, by design.

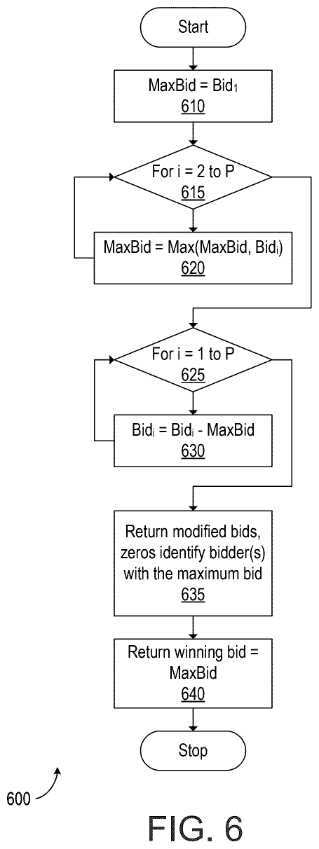

FIG. 6 is a flowchart 600 illustrating a process for homomorphic bid selection and bidder identification for a bidding process seeking the highest or maximum bid, such as an auction. It serves as one example of a process suitable for homomorphic bid selection unit 130, and illustrates an embodiment of steps 220, 225, and 235 detailed above with respect to FIGS. 1 and 2. The first part of the process is to perform a mathematical operation on the encrypted bids to produce an encrypted bid-selection value. In this example, the bid-selection value being sought is the maximum bid of the set of P bids, indicated as variable MaxBid. MaxBid is initialized with the value of the first bid, Bidᵢ(610). Loop through the rest of the P bids, for i=2 to P (615), replacing MaxBid with Max(MaxBid, Bid₁) (620). Because the bids remain in encrypted form, it is not known what the resultant maximum from each iteration was, but the function (such as the example illustrated with respect to FIG. 5) produces the maximum homomorphically.

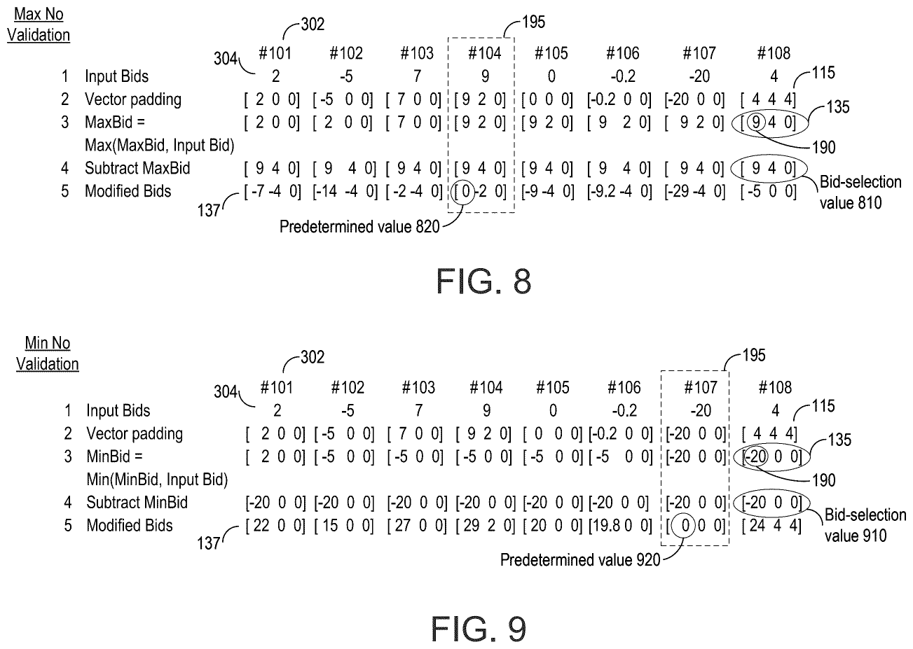

FIG. 8 illustrates results of a bidding process seeking a maximum bid with no validation, using the example bids detailed in FIG. 3. The bid columns have headers with bidder ID values 302, ranging from 101 to 108. Line 1 depicts the bid values 304 for each bidder. Line 2 depicts vector padding to form the encrypted bids 115. Any numbers can be used to pad the vector, including random numbers. In this example, the padding values are to be zero, which is helpful for illustration. A variety of invalid bids are shown for illustration. Bidders 102, 106, and 107 have placed negative bids. Bidder 105 has placed a zero bid. These will not cause an issue when seeking a maximum, but will introduce problems in other examples below, e.g. when seeking a minimum tender. Bidders 104 and 108 have incorrect padding vectors, with non-zero values inserted. Line 3 shows the value of MaxBid, initialized to bid 101, i.e. Bid₁, which is [2 0 0].

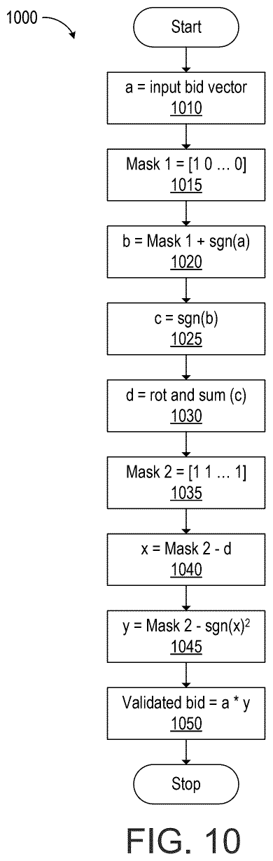

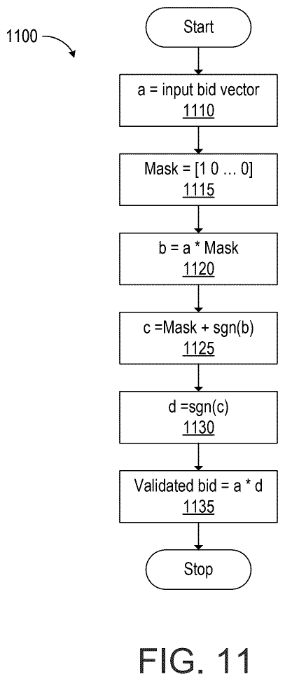

Recall that the values in FIG. 8 are shown in cleartext for illustrative purposes. This process is being carried out homomorphically on third-party server 150. The actual values for all the vectors shown are sets of encrypted polynomials which, if decrypted, would yield the values shown (as described above with respect to FIG. 4). Proceeding to the right on line 3, the value of MaxBid is updated with the Max(MaxBid, Bid₁), where Bid₁ is the input bid of line 2. Bid 102 is less than or equal to MaxBid in each position, so MaxBid remains the same. MaxBid is updated with bid 103, as 7 is larger than 2. MaxBid is updated once more with bid 104, as 9 is greater than 7. Also note that MaxBid is updated in the second position of the vector, as an erroneous 2 in the bid exists. This carries forward past the bids of 0, −0.2, and −20. MaxBid is updated finally with the second element of bid 108, where 4 is larger than 2. So [9 4 0] becomes the maximum bid as well as E(WinBid) 135, which, when ultimately decrypted and decoded yields winning bid 190, with a value of 9. Note that, despite the non-conforming bids, the maximum value was identified, which is presumed to be an acceptable result for this illustration. In an alternate embodiment, if a prerequisite is for all winning bids to be conforming, then this would be erroneous and bid #103, the highest conforming bid of 7 should be selected. Validating bids for this alternate outcome is discussed with respect to FIG. 10, below, in which non-conforming bids are nullified. An alternative validation scheme is introduced following in FIG. 11, in which bids are masked rather than nullified for non-conforming padding.

Returning to FIG. 6, performing a mathematical operation on each encrypted bid with the encrypted bid-selection value is shown. Here, the bid-selection value is used to modify each bid, such that the winning bidders can be identified from the modified bids. In this example, loop on i through each of the P bids (625) and subtract MaxBid from each Bid₁ (630). Once all bids are processed, return the modified bids, from which the winning bidder or bidders can be determined (635). In this example, a predetermined value of zero indicates a winning bidder. The winning bid is also returned, MaxBid in this case (640).

Continuing the example in FIG. 8, MaxBid is used as the bid-selection value 810, which is shown in line 4. The bid-selection value is subtracted from each bid to produce a modified bid 137, and the resultant modified bid or bids that equal a predetermined value 820, which is zero in this example, identify the winning bidder or bidders 195. The winning bidder in this example is bidder #104 with a winning bid of 9. Recall again that, at this point, the bid modifications have been made to identify the winner and the winning bid has been selected, but both the modified bids 137 and the winning bid 135 remain encrypted, and this knowledge is inaccessible to the third-party server without the admin private key. The winning bidder and bid will be revealed after the admin receives the encrypted bids and winning bid, decrypts them, and identifies the winner based on the predetermined value 820.

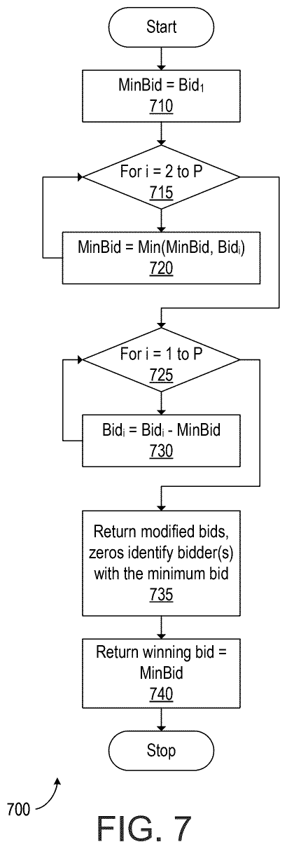

FIG. 7 is a flowchart 700 illustrating a process for homomorphic bid selection and bidder identification for a bidding process seeking the lowest or minimum bid, such as a tender. It serves as another example of a process suitable for homomorphic bid selection unit 130, and, like the maximum example of FIG. 6, illustrates an embodiment of steps 220, 225, and 235 detailed above with respect to FIGS. 1 and 2. As before, the first part of the process is to perform a mathematical operation on the encrypted bids to produce an encrypted bid-selection value. In this example, the bid-selection value being sought is the minimum bid of the set of P bids, indicated as variable MinBid. MinBid is initialized with the value of the first bid, Bid₁ (710). Loop through the rest of the P bids, for i=2 to P (715), replacing MinBid with Min(MinBid, Bid₁) (720). Because the bids remain in encrypted form, it is not known what the resultant minimum from each iteration was, but the function (such as the example illustrated with respect to FIG. 5) produces the minimum homomorphically.

FIG. 9 illustrates results of a bidding process seeking a minimum bid with no validation, using the example bids detailed in FIG. 3. As with the example of FIG. 8, the bid columns have headers with bidder ID values 302, ranging from 101 to 108. Line 1 depicts the bid values 304 for each bidder. Line 2 depicts the same vector padding described above to form the encrypted bids 115. Line 3 shows the value of MinBid, initialized to bid 101, i.e. Bid₁, which is [2 0 0].

As above, the values in FIG. 9 are shown in cleartext for illustrative purposes. This process is being carried out homomorphically on third-party server 150. The actual values for all the vectors shown are sets of encrypted polynomials which, if decrypted, would yield the values shown (as described above with respect to FIG. 4). Proceeding to the right on line 3, the value of MinBid is updated with the Min(MinBid, Bid₁), where Bid₁ is the input bid of line 2. Bid 102 is less than or equal to MinBid in each position, so MinBid is updated with bid 102, as −5 is less than 2. MinBid is updated once more with bid 107, as −20 is less than 7. So [−20 0 0] becomes the minimum bid as well as E(WinBid) 135, which, when ultimately decrypted and decoded yields winning bid 190, with a value of −20. This process has successfully identified the lowest bid value. However, in certain instances, such as tender seeking a monetary price for goods, services, or contracts in general, a positive bid value may be a requirement. Thus, non-positive bids #102, #105, #106, and #107 would be nonconforming and should be eliminated from participation. Example validation processes are detailed further below which accomplish this. As with the example above in FIG. 8, the incorrect vector padding of non-conforming bids (#104 and #108) has not interfered with successfully identifying the minimum bid. This is presumed to be an acceptable outcome in this example. However, in an alternate embodiment it may be desirable to validate the bids to nullify, or remove from potential bid selection, those bids with vector-padding non-conformities. An example is detailed below.

Returning to FIG. 7, performing a mathematical operation on each encrypted bid with the encrypted bid-selection value is shown. Here, the bid-selection value is used to modify each bid, such that the winning bidders can be identified from the modified bids. In this example, loop on i through each of the P bids (725) and subtract MinBid from each Bid₁ (730). Once all bids are processed, return the modified bids, from which the winning bidder or bidders can be determined (735). In this example, a predetermined value of zero indicates a winning bidder. The winning bid is also returned, MinBid in this case (740).

Continuing the example in FIG. 9, MinBid is used as the bid-selection value 910, which is shown in line 4. The bid-selection value is subtracted from each bid to produce a modified bid 137. The resultant modified bid or bids that equal a predetermined value 920, which is zero in this example, identify the winning bidder or bidders 195. The winning bidder in this example is bidder #107 with a winning bid of −20. Recall again that, at this point, the bid modifications have been made to identify the winner and the winning bid has been selected, but both the modified bids 137 and the winning bid 135 remain encrypted, and this knowledge is inaccessible to the third-party server without the admin private key. The winning bidder and bid will be revealed after the admin receives the encrypted bids and winning bid, decrypts them, and identifies the winner based on the predetermined value 920.

FIG. 10 is a flowchart 1000 illustrating a process for validating a bid, referred to as validation option 1. This process applies homomorphic mathematical operations to bids which will validate conforming bids and nullify non-conforming bids. This example turns any negative bid to zero and sets any bid with non-zero padding in the vector to zero. A zero bid is, naturally, already set to zero. After validation, all non-zero bids are considered conforming.

FIG. 12 illustrates the results of applying validation option 1 to the example bids detailed in FIG. 3 and will be described concurrently with FIG. 10. The same bidder IDs, input bid values, and padded vectors used in the previous illustration are shown in lines 1-2. The bid to be validated is identified by variable a (1010). A mask, Mask 1, is generated with a 1 in the vector position in which a bid value is expected, and zeros in all the other positions (1015). In this example, Mask 1 is a vector with a 1 in the first position, and zeros in the remaining positions: [1 0 . . . 0]. At step 1020, b (line 5) is computed as Mask 1 (line4) plus sgn(a) (line 3). Positive values in position 1 (the conforming bid position in this example) will produce a positive sgn value, and so the sum in that position will be 2. Negative, non-conforming values in that position will have a negative sgn value and will cancel out to zero. Zero bid values will result in a 1 in that position. After taking sgn(b)=c (step 1025 and line 6), that bid position now has 1 for all positive bids and zero for all negatives. Bids #102, #106, and #107 have been identified as invalid for being negative, as shown in line 6. The rest of the bids are potentially valid bids. There may still be non-conforming values in the vector padding, which will be removed in the next steps.

At 1030, c is rotated n-1 times, and the n-1 rotations are summed with c to form d (line 7), where n is the size of the vector. A conforming bid will have a value of c=[1 0 0], because it has exactly one positive bid value and has zero padding as prescribed (#101, #103, and #105). For those bids, the sum of rotations d will be [1 1 1]. Bids with any other value of d will have had a non-zero value in the vector padding (#104 and #108). Mask 2 is set to a vector of all ones (1035 and line 8). At 1040, x is computed as Mask 2-d. All valid bids will have x=[0 0 0]. All invalid bids will have a different, non-zero value of x, with the exception of a properly padded zero bid [0 0 0](#105). At 1045, y=Mask 2−sgn(x)² is computed, which produces a validating value. As shown in line 10, y=[1 1 1] indicates a valid value 1210 and y=[0 0 0] is an invalid value 1220. Multiplying the validation value, y, by the original bid (1050) zeros out or nullifies invalid bids and leaves valid bids unchanged. The exception in this illustration is the zero bid #105, which has a valid y value, but the resultant multiplication is zero nonetheless, which renders it indistinguishable from the other invalidated values. As seen in line 11, two bids remain validated (#101 and #103). The invalidated bids 1230 are all nullified (#102 and #104−108). Note that the same validation techniques can be used on encrypted bidder IDs as well (see examples in FIG. 3). The validation value of a bidder ID can be multiplied by the bid, which will nullify any bids with a non-conforming bidder ID.

FIG. 11 is a flowchart 1100 illustrating another process for validating a bid, referred to as validation option 2. This process applies homomorphic mathematical operations to bids which will validate conforming bids and nullify non-conforming bids. This example turns any negative bid to zero. A zero bid is, again, already set to zero. In contrast with option 1, bids with non-zero padding in the vector are not nullified, but rather have the non-zero padding set to zero with a mask, while retaining the value in the bid position in the vector. After validation, all non-zero bids are considered conforming.

In alternate embodiments, the non-bid values in a bid vector can simply be ignored, rather than zeroed. Most of the processes detailed herein comprise vector operations that exhibit positional independence, meaning the computation of each value in the resulting vector is determined solely by the corresponding position in the input vectors. In other words, for each position i, the output at position i is a function exclusively of the input values at position i across the input vectors, with no cross-positional interactions influencing the outcome. It is not suggested to specifically ignore during any particular operation any particular vector component (which is a factor of a polynomial in the example encryption scheme but could be any element in general). Rather, the processes are performed as described, and any “undesired” values in unused positions will be processed along with those in the desired positions, and that processing of unused values can be “ignored”. When the processes are finished, the results in the unused vector can be disregarded.

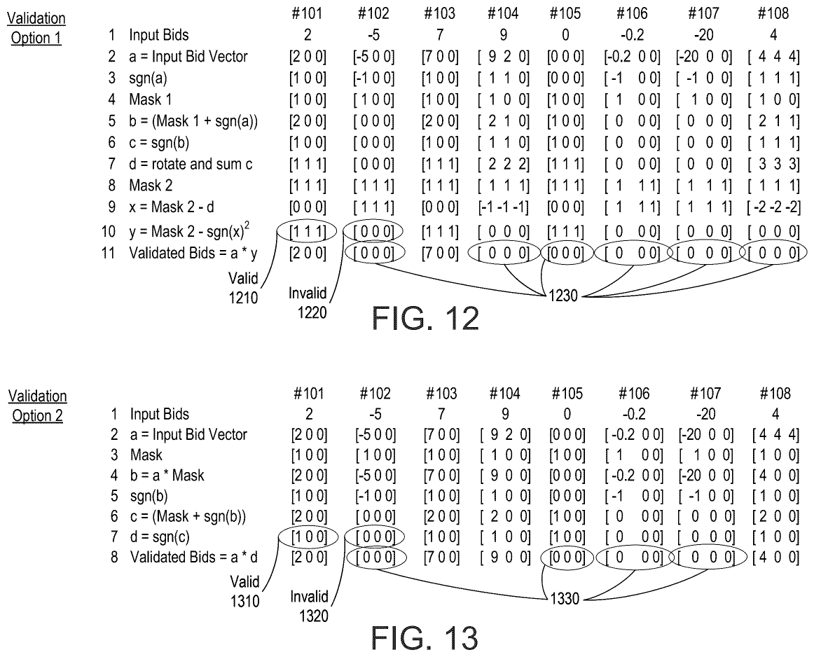

FIG. 13 illustrates the results of applying validation option 2 to the example bids detailed in FIG. 3 and will be described concurrently with FIG. 11. As with FIG. 10, the same bidder IDs, input bid values, and padded vectors used in the previous illustration are shown in lines 1-2. The bid to be validated is identified by variable a (1110). A mask, labeled Mask, is generated with a 1 in the vector position in which a bid value is expected, and zeros in all the other positions (1115). In this example, Mask is a vector with a 1 in the first position, and zeros in the remaining positions: [1 0 . . . 0]. At step 1120, b (line 4) is computed as Mask (line3) multiplied by a (line 2). This step removes any non-zero padding values, allowing any positive bid values to be validated in the following steps. (Step 1120 is optional and can be omitted in embodiments which simply ignore the values in vector positions other than the bid value).

Like in option 1, a validating value d will be computed which can be multiplied by a bid to either validate it (allowing it to remain) or nullifying it (setting it to zero). This is computed by first adding Mask to sgn(b) (1125) (substituting a for b when step 1120 is omitted). As shown in FIG. 13 (lines 5 and 6), when a bid is positive, then sgn(b) added to Mask is 2. When negative, then sgn(b) and the mask will cancel. Zero value bids will result in a c value of 1. At 1130, d is computed as sgn(c). As seen in line 7, for each bid d will be either [1 0 0], indicating valid 1310, or [0 0 0] indicating invalid 1320. At 1135, the validated bid is computed by multiplying d by the input bid a. As before, a zero-value bid will produce a valid d vector, but the result of the multiplication is [0 0 0], an invalid bid. The results are shown in line 8, and the invalid bids 1330 are identified (#102 and #105-107). By comparison with the results of option 1, the positive bids with non-zero padding (#104 and #108) are now validated rather than nullified, along with bids #101 and #103.

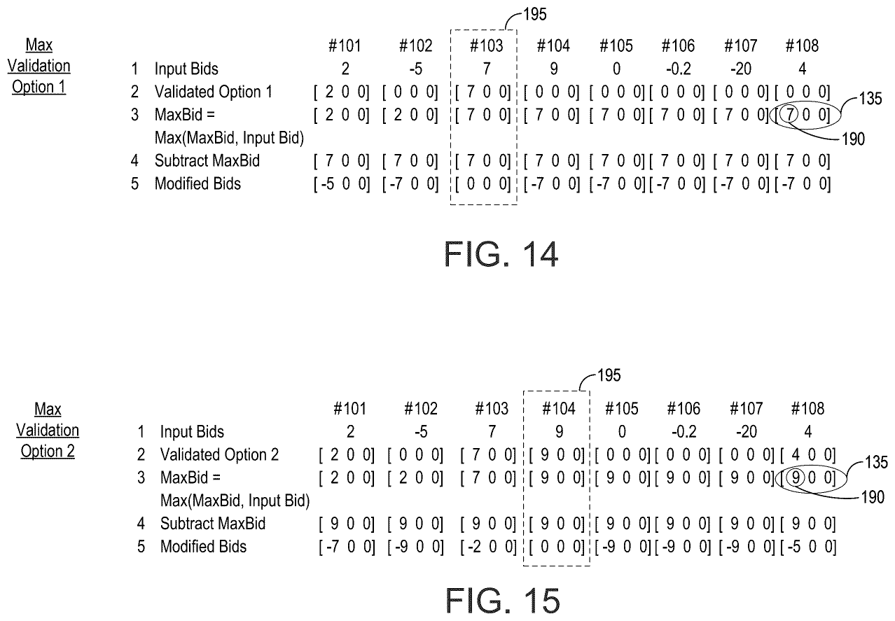

FIG. 14 illustrates results of a bidding process seeking a maximum bid using the bids validated using option 1, determined in FIG. 12. FIG. 14 includes bidding IDs and bid values as detailed in FIG. 8. However, as shown in line 2 the option 1 validated bids have replaced the original bids. MaxBid is determined in line 3, which finds the maximum bid to be [7 0 0], which is returned as E(WinBid) 135, which, when ultimately decrypted and decoded yields winning bid 190, with a value of 7. The modified bids (line 5) result from MaxBid being subtracted from the validated bids in line 2. Bid #103 will ultimately (after encrypted modified bids are sent to the admin for decrypting and processing) be selected as winning bidder 195.

FIG. 15 illustrates results of a bidding process seeking a maximum bid using the bids validated using option 2, determined in FIG. 13. FIG. 15 includes bidding IDs and bid values as detailed in FIG. 8. However, as shown in line 2 the option 2 validated bids have replaced the original bids. MaxBid is determined in line 3, which finds the maximum bid to be [9 0 0]. MaxBid will be returned as E(WinBid) 135, which, when ultimately decrypted and decoded yields winning bid 190, with a value of 9. The modified bids (line 5) result from MaxBid being subtracted from the validated bids in line 2. Bid #104 will ultimately (after encrypted modified bids are sent to the admin for decrypting and processing) be selected as winning bidder 195. This winning bidder and bid are the same as was found in FIG. 8.

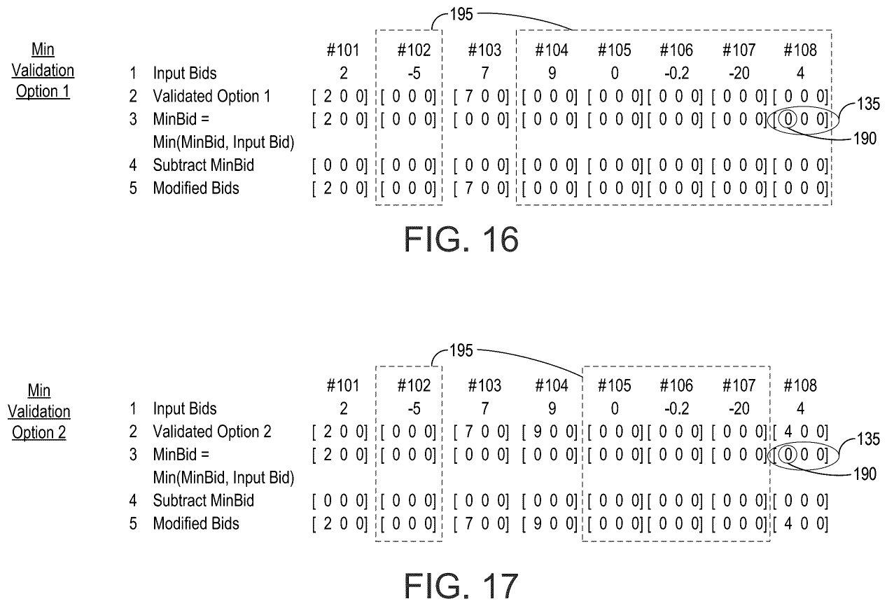

FIGS. 16 and 17 illustrate results for bidding processes seeking a minimum bid using the bids validated using options 1 and 2, respectively. Both include bidding IDs and bid values as detailed in FIG. 9. However, as shown in line 2 the validated option bids have replaced the original bids. In both figures, all the negative values have been replaced with zeros. Option 1 has two valid bids and option 2 has 4. In both cases, MinBid is determined in line 3, which finds the minimum bid to be [0 0 0], which is returned as E(WinBid) 135, which, when ultimately decrypted and decoded yields winning bid 190, with a value of 0. The modified bids (line 5) result from MinBid being subtracted from the validated bids in line 2. A series of the invalid bids will ultimately (after encrypted modified bids are sent to the admin for decrypting and processing) be selected as winning bidders 195. In FIG. 16, that includes bids #102 and #104-108. In FIG. 17, that includes bids #102 and #105-107. In both cases, when a non-zero bid value is expected for a tender, the results are undesirable.

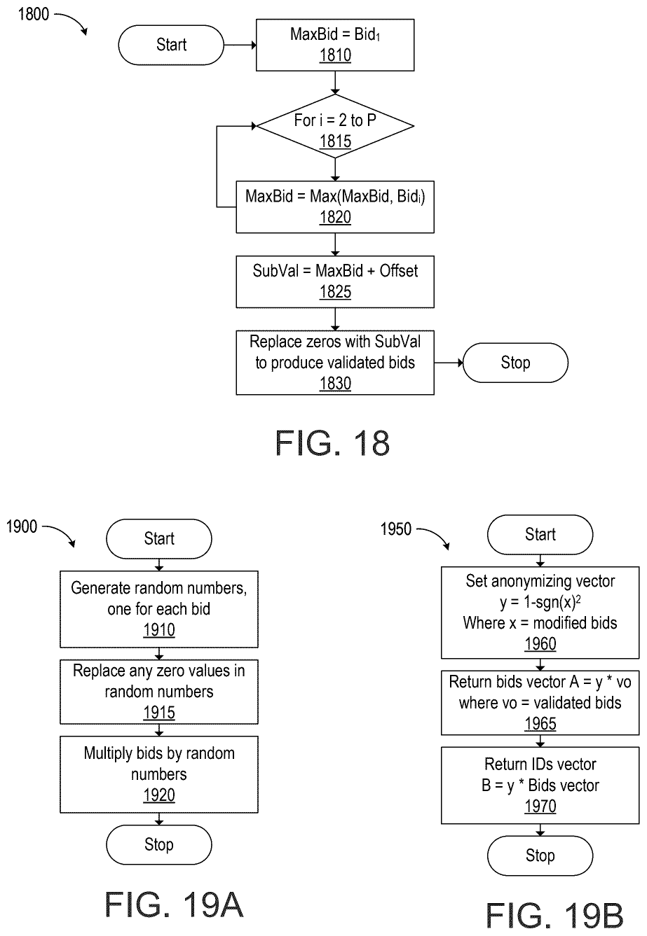

FIG. 18 is a flowchart 1800 illustrating a bid validation process for removing zeros. It is useful for bidding processes requiring positive and non-zero minimum bid selection and bidder identification. The process begins by determining the maximum bid, as illustrated earlier. MaxBid is initialized to the first bid, Bidᵢ(1810). Loop through the remaining P bids, for i=2 to P (1815), and replace MaxBid with Max(MaxBid, Bid₁) (1820). A substitution value is computed that is larger than the maximum bid by adding an offset to the maximum bid (1825). Finally replace any zero bids with the substitution value to produce validated bids (1830). The ReplaceZeros function 592 detailed above in FIG. 5 is a suitable homomorphic function to remove zeros and replace them with the substitution value in encrypted bids. Since the substitution value is greater than the maximum of the non-zero bids, after substitution the minimum can be found using a process such as illustrated in flowchart 700.

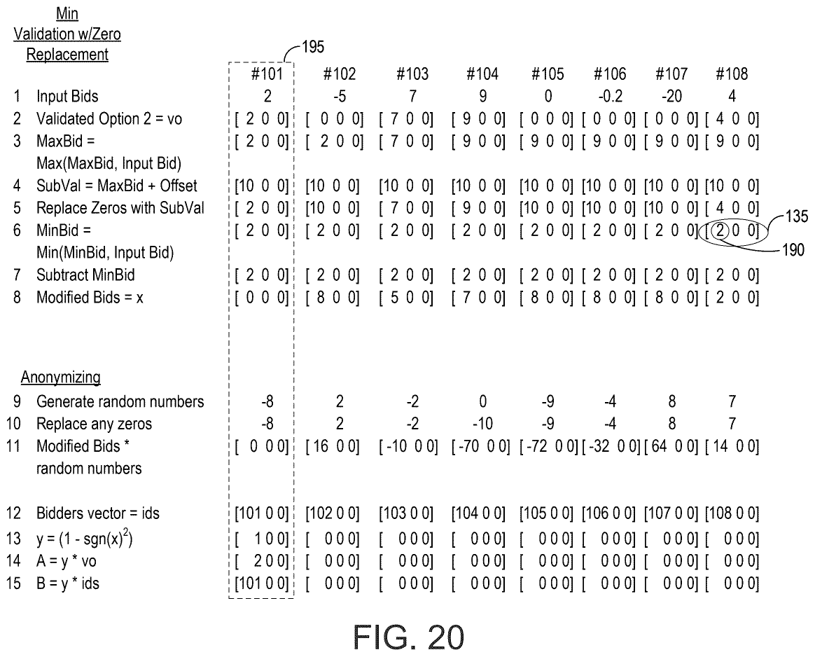

FIG. 20 shows the results of minimum bid selection and bidder identification after zero substitution using the bids validated using option 2. FIG. 20 includes bidding IDs and bid values as detailed in FIG. 8. However, as shown in line 2 the option 2 validated bids have replaced the original bids. The bids are further validated using the process of flowchart 1800. MaxBid is determined in line 3, which finds the maximum bid to be [9 0 0]. SubVal is computed in line 4. An offset of [1 0 0] is used, resulting in SubVal=[10 0 0], although any positive offset would suffice. Line 5 shows the results of replacing zeros with SubVal to produce zero-replaced validated bids.

The ReplaceZeros computation is illustrated with the first two bids:

$$ReplaceZeros ( [ \begin{matrix}2 & 0 & 0\end{matrix} ] , [ \begin{matrix}1 & 0 & 0 & 0\end{matrix} ] )$$

$$= [ \begin{matrix}2 & 0 & 0\end{matrix} ] + [ \begin{matrix}1 & 0 & 0 & 0\end{matrix} ] ( 1 - sgn ( [ \begin{matrix}2 & 0 & 0\end{matrix} ] ) )$$

$$= [ \begin{matrix}2 & 0 & 0\end{matrix} ] + [ \begin{matrix}1 & 0 & 0 & 0\end{matrix} ] ( [ \begin{matrix}1 & 0 & 0\end{matrix} ] - [ \begin{matrix}1 & 0 & 0\end{matrix} ] )$$

$$= [ \begin{matrix}2 & 0 & 0\end{matrix} ] + ( [ \begin{matrix}1 & 0 & 0 & 0\end{matrix} ] [ \begin{matrix}0 & 0 & 0\end{matrix} ] )$$

$$= [ \begin{matrix}2 & 0 & 0\end{matrix} ]$$

$$ReplaceZeros ( [ \begin{matrix}0 & 0 & 0\end{matrix} ] , [ \begin{matrix}1 & 0 & 0 & 0\end{matrix} ] )$$

$$= [ \begin{matrix}0 & 0 & 0\end{matrix} ] + [ \begin{matrix}1 & 0 & 0 & 0\end{matrix} ] ( 1 - sgn ( [ \begin{matrix}0 & 0 & 0\end{matrix} ] ) )$$

$$= [ \begin{matrix}0 & 0 & 0\end{matrix} ] + [ \begin{matrix}1 & 0 & 0 & 0\end{matrix} ] ( [ \begin{matrix}1 & 0 & 0\end{matrix} ] - [ \begin{matrix}0 & 0 & 0\end{matrix} ] )$$

$$= [ \begin{matrix}0 & 0 & 0\end{matrix} ] + ( [ \begin{matrix}1 & 0 & 0 & 0\end{matrix} ] [ \begin{matrix}1 & 0 & 0\end{matrix} ] )$$

$$= [ \begin{matrix}1 & 0 & 0 & 0\end{matrix} ]$$

With the zeros replaced, the modified bids (line 5) can be processed to find the minimum as described above. MinBid (line 6) is initialized with the first bid, [2 0 0]. Proceeding to the right, this bid will remain the minimum bid. Thus [2 0 0] becomes the minimum bid as well as E(WinBid) 135, which, when ultimately decrypted and decoded yields winning bid 190, with a value of 2. Line 8 shows the modified bids after MinBid is subtracted from each. Note that winning bidder 195 will be identified as #101 once the modified bids have been decrypted and processed, since it is the only zero value bid.

FIG. 20 further illustrates the benefits of optional bid anonymization. In this context, anonymizing a bid is synonymous with keeping it confidential. When bids are anonymized, only the winning bid value will be discernable at the end of the process. Bidder identities may also be anonymized (as detailed in bidding system 2700 below), but, even if a bidder identity is known in a particular embodiment, that bidder's anonymized bid will be kept confidential (unless it is the winning bid). It can be seen that with the cleartext of the modified bids and the winning bid value of 2, all of the valid bids can be reconstructed by adding back the bid value to the modified bid. It can be inferred that the maximum modified bid value is likely to be an invalid bid that was validated to zero (or started as a zero) and then replaced with MaxBid. But it is known with certainty that those less than that, #103, #104, and #108 in this example, were valid bids with bid value 7, 9 and 4, after adding 2 to their modified values of 5, 7 and 2, respectively. This information is not needed to identify the winning bid and bidder. But, given that information about competitors may be of interest to a bidder, particularly in an industry where a group of parties is routinely competing with each other over time, a potential opportunity for a bad actor with access to the admin data is created to collude with a bidder and provide this industrial intelligence. To prevent this, it may be desirable to anonymize the modified bids, such that winning bidders are still identifiable, but no information remains about any of the non-winning bid values.

FIG. 19A is a flowchart 1900 illustrating an anonymizing process. A series of random numbers is generated, one for each bid (1910). If any of the random numbers is a zero, it is replaced (1915), so that there is no erroneous modification of a non-winning bid value to zero. The bids are then multiplied by the random numbers. The zeros remain, but all the other bids are now random, and any bid information has been obscured. This randomization process illustrated in FIG. 19 can be combined with any embodiment, such as those detailed herein, where bid values are to be dissociated with non-winning bidders. Random numbers are just one example of anonymizing values that can be used. Any series of non-zero values can be used to multiply with the modified bids to obscure the non-winning values, so long as those values are not known or shared with the decrypting entity (the admin in this example). Typically, the values should vary, so as not to allow for relative comparisons of the non-winning bids as well. Anonymizing can be performed with plain text or encrypted anonymizing values with the same effect.

This is shown in FIG. 20, where random numbers are generated as shown in line 9. The zero for bid #104 is replaced with −10 in line 10. Line 11 shows the anonymized modified bids. It can be seen that the bid information for the non-winners is gone, and the winning bid, #101, remains at [0 0 0] and identifies the winning bidder, who bid the winning bid of 2. The randomized modified encrypted bids of line 11, along with the encrypted winning bid 135 are delivered as encrypted bidding process results to the admin to decrypt both and identify the winning bidder and winning bid 190.

FIG. 19B is a flowchart 1950 illustrating an alternate anonymizing process. Example results are shown in lines 12-15 of FIG. 20. In this example, a vector of bids, vo, is identified as the validated bids from line 2. A vector of the bidder identifications, ids, is shown on line 12, where the positions in ids and vo correspond to bidder/bid pairs. Aₙ anonymizing vector y is produced from the vector of modified bids, set to x, where y=1−sgn(x)² (1960). This sets all the non-winning bid positions in the anonymizing vector to zero and sets the winning bid(s) to 1, as shown in line 13. The only nonzero vector position is the one associated with winning bidder #101. Note that in this example, a minimum bid is being sought, but the technique works equally for seeking a maximum (in which the non-winning bids will all be negative). The anonymizing vector can be multiplied by the vector of bids (1965) to produce an anonymized bid vector, A=y*vo, with results shown on line 14. Again, the only nonzero vector position is the winning bid, [2 0 0]. The anonymizing vector can also be multiplied by the bidder identifications (1970) to produce an anonymized bidder ID vector, B=y*ids, with results shown on line 15. Here bidder 101 is identified. In this example, the vectors A and B are returned as encrypted bidding process results to the admin for decrypting, and the only data available to the admin will be the identification(s) of the winning bidder(s) and value of the winning bid. The admin will not know the identity of bidders who submitted a bid other than the winner(s).

In an alternate embodiment, the steps of lines 1-11 of FIG. 20 are performed as described. An additional set of second modified bids is then generated (details not shown) as F=Z+vo (where Z is defined as the results in line 11. In this example, Z=[2 0 0][16 0 0][−3 0 0][−61 0 0][−72 0 0][−32 0 0][64 0 0][18 0 0]. Z and F are returned as encrypted bidding process results to the admin for decrypting. In this embodiment, lines 12-15 of FIG. 20 are performed at the admin, with a few modifications. Lines 12 and 15 are identical. Line 13 is computed as y=(1-sgn(Z)²). Line 14 is computed as A=y*F. The data available to the admin will be the identification(s) of the winning bidder(s) and value of the winning bid. The admin can discern the identity of non-winning bidders via line 12. No details of the original bid values or the difference between them is known at the admin.

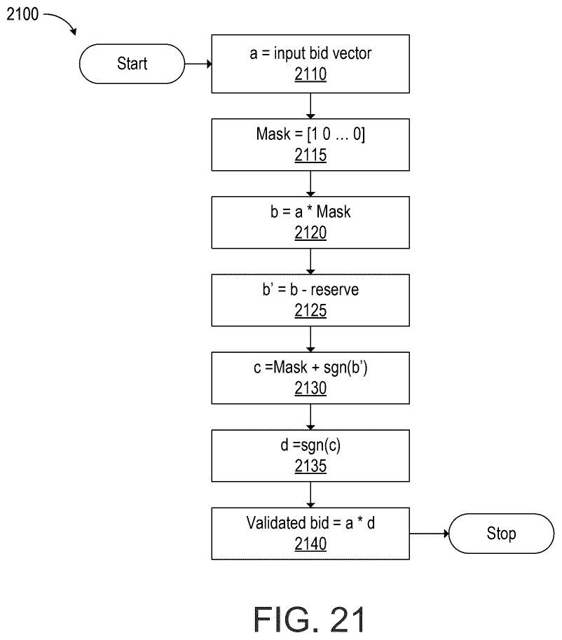

FIG. 21 is a flowchart 2100 illustrating validation of bids in a bidding process seeking a maximum bid and supporting a minimum reserve value. The process begins by selecting an input bid vector identified as a (2110). A mask vector with a 1 in the bid value position of the vector and zeros in the other positions is defined as Mask (2115). Mask is multiplied by a to form b (2120). In alternate embodiments, the non-bid values in a bid vector can simply be ignored, rather than zeroed, and step 2120 can be omitted, in which case b=a.

A validating value d is calculated which is multiplied by the bid values to modify them such that bids that are below the reserve value are nullified. The validating value is a zero vector (or, in general, an additive identity) when the reserve is not met. The validating value is a vector incorporating a one in the bid value position (or, in general, a multiplicative identity) when the reserve value is met. The value is computed by subtracting the reserve value from b to form b′ (2125). Bids under the reserve will have negative b′ values. A bid at the reserve will have a zero b′ value. Mask is then added to sgn(b′) to form c (2130), where negative b′ values will be cancelled to zero, positive b′ values will yield a 2, and a zero b′ value results in a 1. Validating value d is then formed as sgn(c), which validates all bids at or above the reserve level (2135). The validated bids are modified by multiplying them by their respective d values (2140).

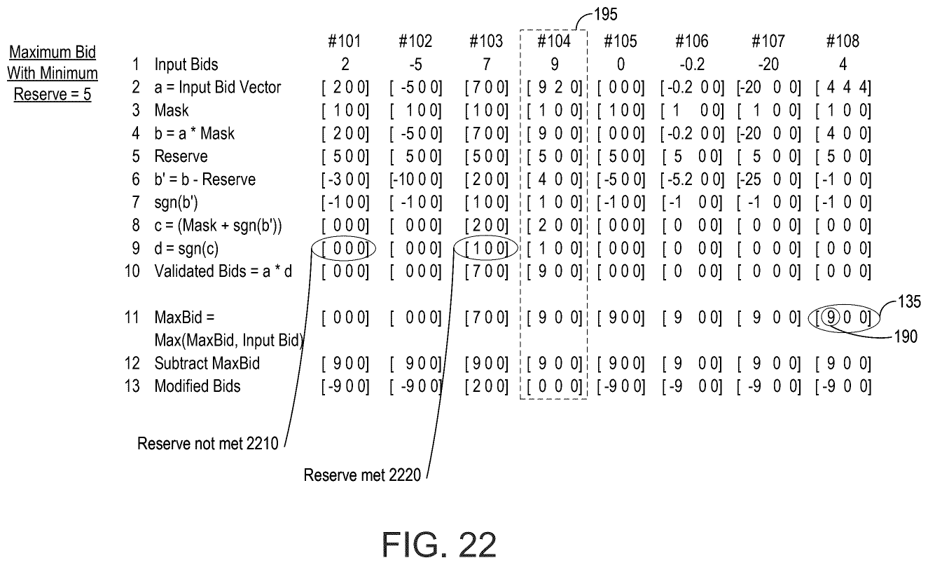

FIG. 22 illustrates results for an example seeking a maximum bid with a minimum reserve value of 5. Bidding IDs, bid values, and bid vectors are as detailed in FIG. 8. Mask values [1 0 0] are shown in line 3. Optional masking occurs on line 4, which removes any non-zero padding in the vector. The reserve value, Reserve, of 5 is shown in line 5. Line 6 shows b′ as b—Reserve for each bid. Line 8 shows the results for c=Mask+sgn(b′). Note all the values are either [0 0 0] or [2 0 0] for unmet and met reserve bids, respectively. A bid at the reserve would be [1 0 0](not shown). Taking sgn(c) produces d, as shown in line 9, and the validated bids are then generated by multiplying the original bids a by d as shown in line 10. Note that a [0 0 0] validating value 2210 applies when the reserve is not met and a [1 0 0] validating value 2220 applies when the reserve is met.

The process of flowchart 600 can then be applied, with results shown in line 13. The winning bidder 195, #104, will be identified once bids are decrypted as the only bid with [0 0 0]. MaxBid (line 11) is found as [9 0 0], which will be delivered as E(WinBid) 135 and eventually decrypted to produce the winning bid 190 with value 9.

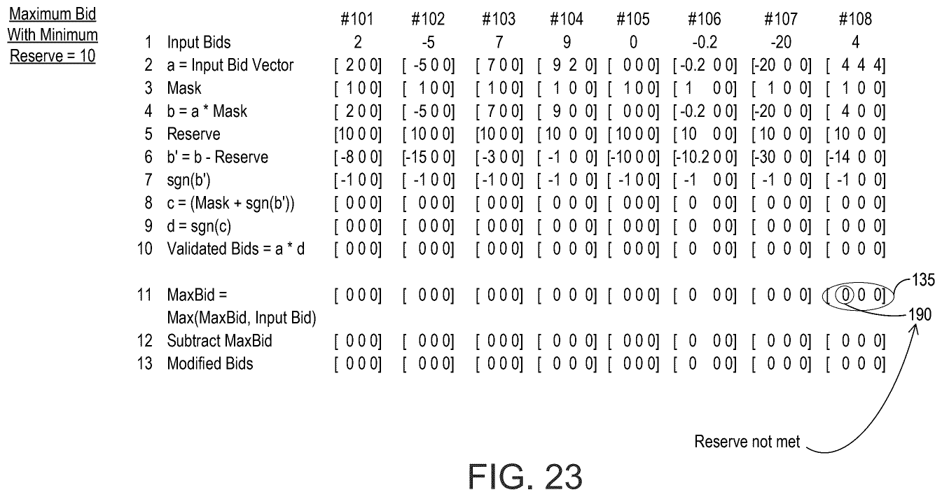

FIG. 23 illustrates results for an example seeking a maximum bid with a minimum reserve value of 10. In contrast with FIG. 22, which had several bids above the reserve, there are no bids above the reserve of 10 (line 5). In this case, b′ will be negative for all bids, and hence d will be [0 0 0] for all bids, indicating reserve not met (line 9). Therefore, all bids will be nullified (lines 10-13). Here the MaxBid will be [0 0 0], which will be delivered as E(WinBid) 135 and eventually decrypted to produce the winning bid 190 with value 0. The winning bid of value 0 allows the admin to deduce the reserve was not met, rather than all bids being equal to each other and having met the reserve, which would be indicated by a non-zero bid.

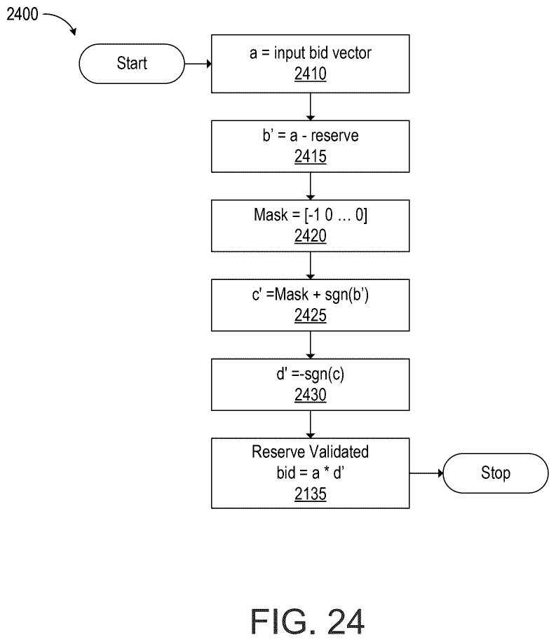

FIG. 24 is a flowchart 2400 illustrating validating bids for a bidding process seeking a minimum bid with a maximum reserve value. An input bid vector is selected as a (2410). The maximum reserve value is subtracted from a to produce b′ (2415). Any bid below the maximum reserve value will now be a negative number (invalid 0 or negative bids will also be negative but will be handled in subsequent processing as detailed above). A mask is formed with a negative one in the bid value position of the bid vector and all zeros in the other positions (2420). The mask is added to sgn(b′) to form c′ (2425). At this point, c′ will have a −2 in the bid value position for all bids under the maximum reserve threshold, a −1 for bids at the threshold, and a zero above the threshold. A validating value d′ is computed as −sgn(c) (2430), which captures the bids with −1 or −2 in the bid value position of c′, those at or below the maximum threshold, respectively. A reserve validated bid is computed by multiplying the bid by the validating value, a*d′ (2135).

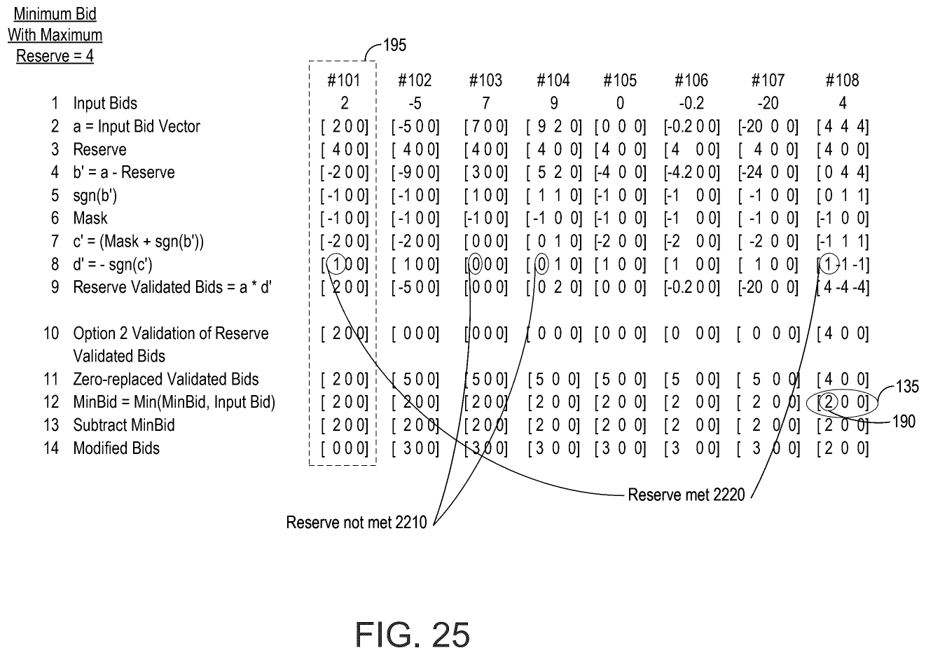

FIG. 25 illustrates results for an example maximum reserve value of 4. Bidding IDs, bid values, and bid vectors are as detailed in FIG. 8. Optional masking is not used in this example, so padding values outside of the bid value position in the bid vector (such as #104 and #108) are simply ignored. The reserve value, Reserve, of 4 is shown in line 3. Line 4 shows b′ as a—Reserve for each bid. Line 7 shows the results for c′=Mask+sgn(b′). Note all the values (ignoring values in the vector-padding positions) are either [−2×x] or [−1×x] for bids below or at the reserve, respectively, and [0×x] for bids exceeding the reserve. Taking the −sgn(c) produces d′, as shown in line 8, and the reserve-validated bids are then generated by multiplying the original bids a by d′ as shown in line 9. The validating values 2220 for those bids with the reserve met are shown for bids #101 and #108 (similar values appear for the other invalid bids which are ignored at this point in the process). Validating values 2210 for those bids not meeting the reserve are highlighted for bids #103 and #104, both of which have bid values above the reserve value of 4. In line 9, it can be seen those bids have been nullified to [0×x](again, padding values being ignored in this example).

Validation option 2 (as detailed in FIG. 13) is then applied to the reserve-validated bids to produce the option 2 validated reserve-validated bids shown in line 10. Now the invalid bids that happened to meet the reserve maximum have been nullified. The zeros are then replaced (as detailed in FIG. 20) to produce the bids on line 11. The process of flowchart 700 can then be applied to these results, with modified bids shown in line 14. The winning bidder 195, #101, will be identified once bids are decrypted as the only bid with [0 0 0]. MinBid (line 12) is found as [2 0 0], which will be delivered as E(WinBid) 135 and eventually decrypted to produce the winning bid 190 with value 2.

If the reserve condition is not met, then, in similar fashion to the minimum reserve bid scenario detailed in FIG. 23, all the modified bids will be returned as encrypted zeros. Again, however, the minimum bid 135 will also be returned as a decrypted zero. When the admin decrypts and analyzes, this scenario indicates that the reserve was not met, and all the bids represent either valid bids above the reserve or invalid bids having been nullified. Aₙ example would be to set the reserve in line 3 to [1 0 0]. This would cause bids #101 and #108 to be nullified by resultant validating values d′. Bids #102, #106, and #107 would remain as shown in line 9, but would be subsequently nullified as invalid. The encrypted modified bids and winning bid would all decrypt to zero and the admin would deduce the reserve was not met (details not shown).

Note that reserve values can be supplied to the third party in encrypted form from any party, including the admin, or, if the auction client wishes to keep the reserve value a secret, that party can encrypt with the public key and supply it to the third party for validating. The admin will know when there is a non-zero winning bid, to indicate that the reserve has been met. In that case the reserve must be equal to or lower than the winning bid (in the case of an auction-type bidding process), or equal to or higher than the winning bid (in the case of a tender-type bidding process). Other than that, no information about the reserve is available. When the winning bid and all the decrypted modified bids are all zero, the admin will know the reserve was not met but have no indication about what the bids were or what the reserve value was.

In the example validation method 1100, and the associated results described in FIG. 13, a single bid in a single position in the vector is expected. In an alternate embodiment, a bid vector may contain bids for more than one auction or tender item, or for more than one auction or tender. Such a bidding system supports bidding processes that receive bids containing multiple bid values, each for one of multiple bidding events, such as bids for multiple items, multiple jobs, multiple auctions, multiple tenders, and the like. In that case, the mask will be generated with a one in any position for which a bid is expected. The exact same steps detailed in method 1100 may be performed (with step 1115 again being optional), and the resultant validated vector will have a validated bid in each position (details not shown). The various methods detailed herein may then be applied to find maximum bids, or minimum bids, either with or without reserves. A reserve vector can have different values in different positions for different bidding processes. The resultant maximum or minimum bid 135 will have maximum or minimum bids 190 in each vector position identified for the multiple bidding processes. The modified bids will have only one zero in the position for each bidding process, from one or more bidders, identifying the winner or winners (with the exception of a reserve not being met, as described above, in which case the winning bid in that position will also be zero).

A variety of techniques may be used to facilitate homomorphic multi-bid processes. For example, a first option is to use masking and rotation to extract bids for multiple bidding processes. Table 1 illustrates an example of an input vector [9 4 0] supporting two bidding processes. A mask [1 0 0] is used to extract the first bid value [9 0 0]. Then the input vector is rotated as shown [4 0 9]. Then the same mask can be used to extract the second bid value [4 0 0]. Using this technique, the bids for each bidding process can be extracted and separated and each bidding process may be performed using any of the techniques described previously.

TABLE 1
Multi-bid Option 1

| | |
|---|---|
| Input vector | [9 4 0] |
| Mask | [1 0 0] |
| Extract Bid 1 | [9 0 0] |
| Rotate | [4 0 9] |
| Mask | [1 0 0] |
| Extract Bid 2 | [4 0 0] |

In a second option, multiple bidding processes can be performed on the same set of multi-bid input vectors using a set of masks, one for each process. Using the previous example, two masks, [1 0 0] and [0 1 0] can be used to distinguish the values for each bidding process while performing bid processing using any of the techniques described previously.

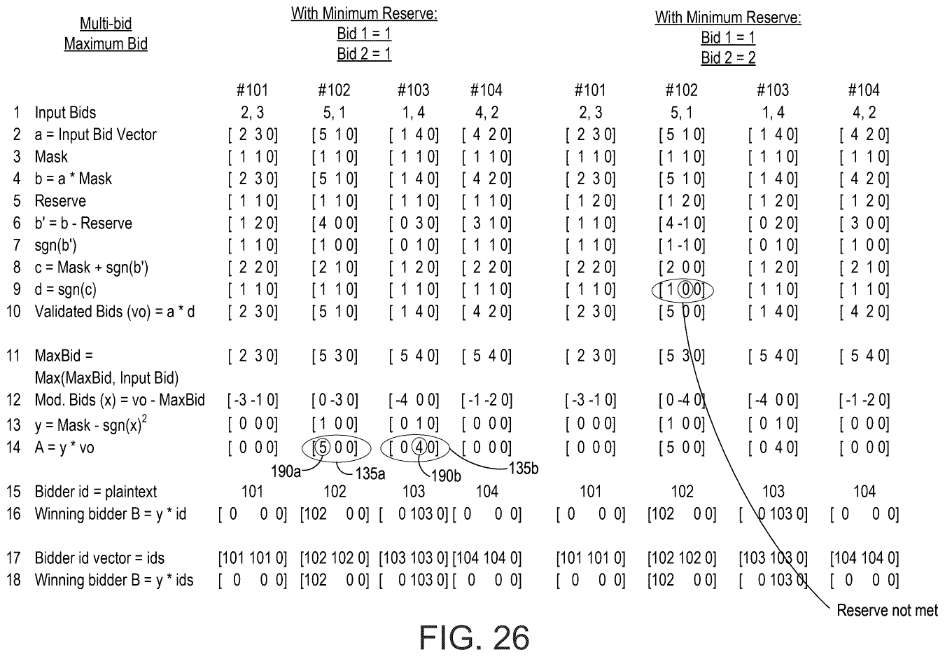

A third option, introduced above, is to use the homomorphic properties of vector processing to simultaneously evaluate multiple bids on a set of input vectors comprising multiple bid values. FIG. 26 illustrates example multi-bid results with differing reserve values. This example shows the results for two bidding processes, each seeking the maximum bid with a minimum bid reserve requirement. Bids for 4 bidders, 101-104, are shown on line 1. Two sets of columns illustrate differing reserve values. In the left set of columns, the reserve for the first and second bidding processes are set to 1. In right set of columns, the reserve for the second bidding process is modified to 2.

Using techniques detailed earlier, the bids will be validated to satisfy the reserve minimums. The input bid vectors a are shown on line 2. The mask on line 3 shows a 1 in each position of the vector representing a valid bidding process, [11 0] in this example for the two bidding processes. Line 4 shows b=a*Mask (optional). The reserve values are shown on line 5. For the first example (left set of columns) the reserve value is [11 0] indicating that the minimum bid for each bidding process is 1. For the second example (right set of columns), the reserve value is [1 2 0], indicating that the reserve value for the second bidding process is set to 2. These examples illustrate that different reserve values for different bidding processes are supported. The validation values d are shown on line 9. Validation values are computed by forming b′=b—Reserve (line 6), taking sgn(b′) (line 7), forming c=Mask+sgn(b′) (line 8), and producing d=sgn(c). For the first example, each validation value is [1 1 0], where the 1 in each position indicates all the bids have satisfied the reserve for each bidding process. Contrast this with the results for the second example. Here, all bids have satisfied the reserve for the first bidding process (as it is the same as for example 1), and bids for 101, 103, and 104 have also met the reserve of 2 for the second bidding process (as indicated by a 1 in the second position in each respective validating value). However, bid 102 did not meet the reserve (1<2) and so the validating value for 102 is [1 0 0], signifying that the first bidding process reserve is met but the second is not. Validated bids (vo) are formed as a*d (line 10). Note that all bids are identical to the input bids (there were no formally invalid bids introduced in these examples) except for bid 102 in the second example transforming from [5 1 0] to [5 0 0]. The second value in the vector has been invalidated for failing to meet the reserve. The first value in the vector is unchanged.

The maximum bid [5 4 0] is determined on line 11. From that, the encrypted bid selection values y are formed as shown on line 13. Those values are formed by computing modified bids x=vo−MaxBid (line 12) and then y=Mask is sgn(x)². It can be seen that the values of y are all zeros for the losing bids, and a 1 in each position to select the two winning bids. Note that it is possible for one bidder to win both bids, and there could be ties as detailed earlier. The winning bids are formed as A=y*vo (line 14). Here the encrypted winning bid 135a for the first bidding process ultimately decrypts and decodes to yield winning bid 190a, with a value of 5. Similarly, the encrypted winning bid 135b for the second bidding process ultimately decrypts and decodes to yield winning bid 190b, with a value of 4.

There are two embodiments for identifying the winning bidders illustrated in FIG. 26. First, when a plaintext bidder id is supplied, as shown on line 15, then the winning bidders B can be found in encrypted form by multiplying the plaintext id by the encrypted bid selection values y. As shown, the appropriate bidder identifications, 102 for the first bidding process and 103 for the second, are shown on line 16. These can be decrypted along with the winning bids A, where only the winning bids A and winning bidders B will be identified.

In a second example embodiment, the bidder ids are encrypted vectors as shown in line 17. The Bidder id is repeated in all the vector locations corresponding to valid bid values. Here, the first two locations bear the bidding value, and so the bidder id is made available in the first two locations of the Bidder ID vectors. Then, as shown in line 18, the winning bidders B are identified by decrypting the result of B=y*ids.

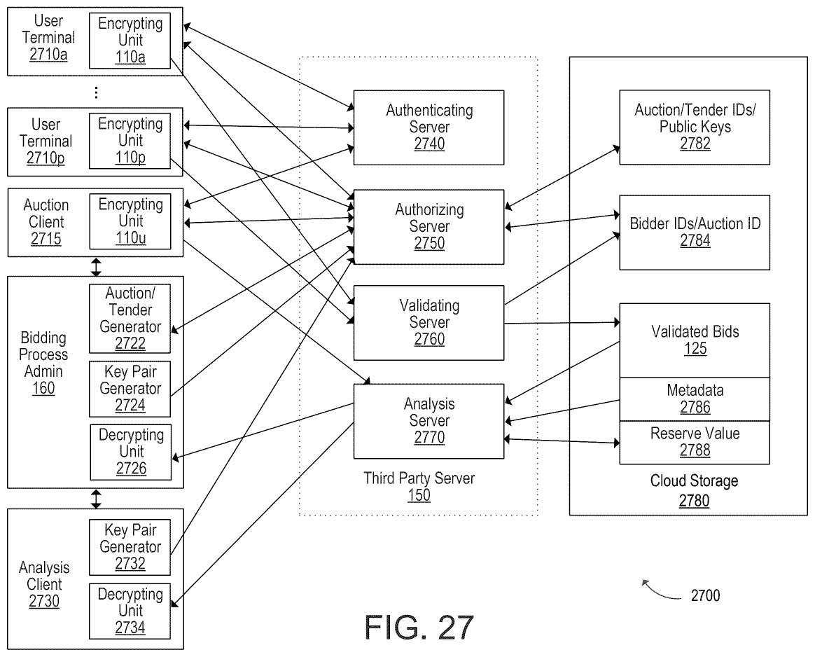

FIG. 27 is an example bidding system 2700. Examples and methods of encryption, validation, and analysis have been detailed above, and are suitable for deployment in such a system. In addition, various aspects of and benefits for online bidding can be enjoyed when the system is designed with distributed functionality, as illustrated in FIG. 27, and with related figures detailed further below.

The encrypted analysis results, including modified bids and the winning bid, in the example embodiment, are produced in a first computational device without access to the decryption key associated with the encrypted data. The encrypted results are made available to a second computational device, having the key, for decryption. The encrypted data, such as the individual encrypted bids, are not made available to the second computational device. In this way, anonymity is preserved, by preventing the first device from having the means to decrypt and restricting the second device from any results other than pseudonymized or modified data.

A bidding process administrator, or admin 160, initiates the process of creating a bidding process, such as an auction or a tender. It is equipped with an auction/tender generator 2722, a key pair generator 2724, and a decrypting unit 2726.

The admin 160 interfaces with third-party server 150 to initiate a bidding process and receive encrypted bid results, including modified bids and the winning bid value. Third-party server 150 is shown comprising various functions such as authenticating server 2740, authorizing server 2750, validating server 2760, and analysis server 2770. Users participate in the bidding system 2700 via user terminals 2710, each of which comprises an encrypting unit 110 for preparing encrypted bids. User terminals 2710 interface with various third-party servers 150. Authenticating server 2740 authenticates the user with a valid identification, authorizing server 2750 authorizes the user to participate in a particular auction or tender, and validating server 2760 receives encrypted bids from the user terminal 2710 for validation.

An auction client 2715 (optionally using a user terminal 2710 with an encrypting unit 110) can communicate with the bidding process administrator 160 to set parameters for and receive results from an auction or tender created on its behalf. As described above, an auction client can provide an encrypted reserve value to the third-party server 150 to support reserve validation. The encrypted reserve value 2788 is stored in cloud storage 2780.

Cloud storage 2780 is connected to third-party servers 150 to store a variety of information related to bidding process administration, such as identifications for each bidding process (auction/tender IDs) and their associated public keys 2782, identifications of users (bidder IDs, either plaintext or encrypted) for each auction or tender (by auction/tender ID) 2784, validated bids 125, associated metadata 2786 (which can be optionally anonymous/pseudonymous), and encrypted reserve value 2788.

Optionally, one or more analysis clients 2730 may communicate with analysis server 2770 to receive bid analysis for which it is authorized. The levels of bid analysis can be different for the admin 160 and each analysis client 2730. Since all results from analysis server 2770 are encrypted, analysis client has a decrypting unit 2734. In some embodiments, analysis client may use a key pair generator 2732 to provide its own public key for encrypting analysis results directed to it. In other embodiments, analysis clients 2730 may cooperate directly with admin 160 to receive private results from it or share the private key. Each entity (whether admin 160, analysis client 2730, or other entity) can receive analysis results tailored for the specific entity, based on any technique.

While the functions of third-party server 150 may reside in one server, in various embodiments one or more of those functions may be distributed between one or more independent third-party servers. Storage for bidding process administration is not required to be cloud-based, it could reside on one or more of the various third-party servers 150. However, it is another design element variable.

System design considerations including security, anonymity, and ease of administration may lead to various configurations, depending on the system requirements. In one example, a key aspect is anonymity and security. Each user encrypts their individual bid. A third-party processes bids, always encrypted. Cloud storage may be administered by the same entity as the server, but that is not necessary. Cloud storage may be made visible, in whole or in part, to one or more entities to provide auditing of results (in encrypted form, according to desired level of anonymity). Entities such as a bidding process admin, along with optional analysis clients, have access to decrypted data, but only modified or pseudonymous in this example. Various entities in alternative embodiments may participate together to provide distributed public key encryption to provide additional security, wherein each entity cooperates to decrypt their respective results. An optional analysis client (or other entities) may use distributed key generation, such that cooperation is required for decryption, allowing for only a single entity to remain trustworthy for the system to remain secure (i.e., all entities would have to collude to cheat). Admin 160 could have access to all analysis, or it can be parsed as desired by analysis server 2770. More specific information can be granted to various entities based on access privilege settings.

An online polling system for validation and analysis of encrypted bids is detailed in copending U.S. patent application Ser. No. 18/799,064, entitled “Homomorphic Encryption for Online Voting,” filed on 9 Aug. 2024, by Seenivasagam et al., which is incorporated herein by reference, hereinafter the '064 application. The components of that polling system comprise many of the same components of bidding system 2700, including an administrator for generating keys and decrypting results, a third-party server for authentication, authorization, homomorphic validation, and homomorphic analysis of encrypted user responses. The online bidding system 2700 can be adapted to combine both online polling and bidding. Alternatively, the system of the '064 application can be adapted to support embodiments detailed herein.

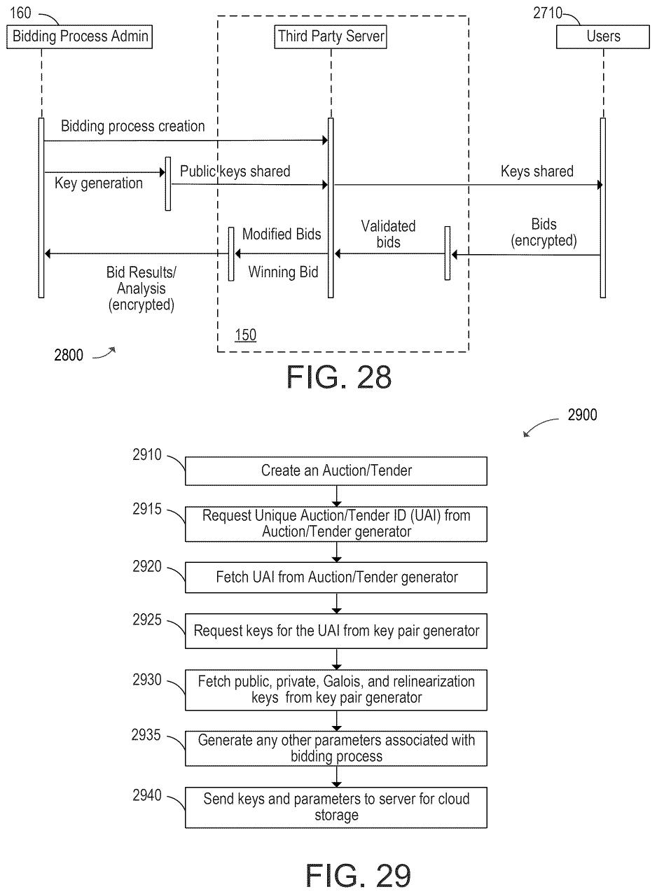

FIG. 28 illustrates a process flow 2800 for bidding system 2700. The process flow is divided into five general phases: bidding process creation, online bidding response, validation, analyzing, and results extraction. Admin 160 initiates the bidding creation process with third-party server 150.

FIG. 29 is a flowchart 2900 illustrating an example bidding creation process. The bidding process admin creates an auction or tender form (2910), such as a ballot, survey, or any other set of questions and possible responses. A request is made (2915) to the auction/tender generator 2722 for a Unique Auction/Tender Identifier (UAI). Each auction or tender created by the bidding process admin will have its own unique identifier. A UAI is made and fetched (2920) from the auction/tender generator 2722. A request for keys to be associated with the UAI is made (2925). In the example embodiment, using CKKS, the keys are generated and fetched (2930) including public, private, Galois, and relinearization keys, as detailed above. Any other parameters that are needed for the bidding process are generated (2935). The private key is retained by the bidding process admin for decrypting results when they are generated. The public and other keys are sent (2940) to the third-party server for storage in cloud storage 2780.

Returning to FIG. 28, the public keys will be shared with users 2710 in the online bid phase. Users (having been authenticated and authorized) will make their selections in response to the auction or tender, and their bids will be encrypted and returned to the third-party server 150 for validation.

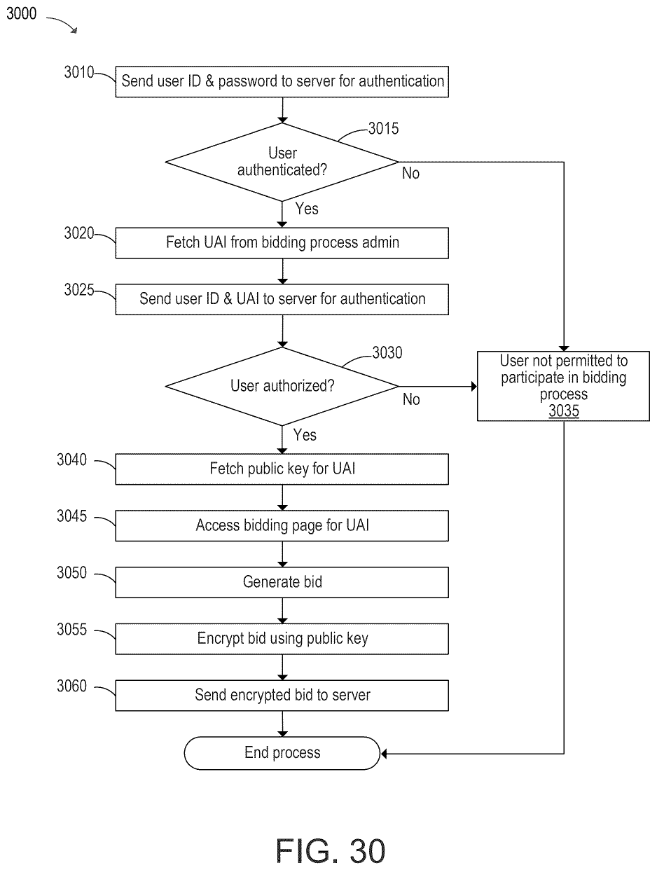

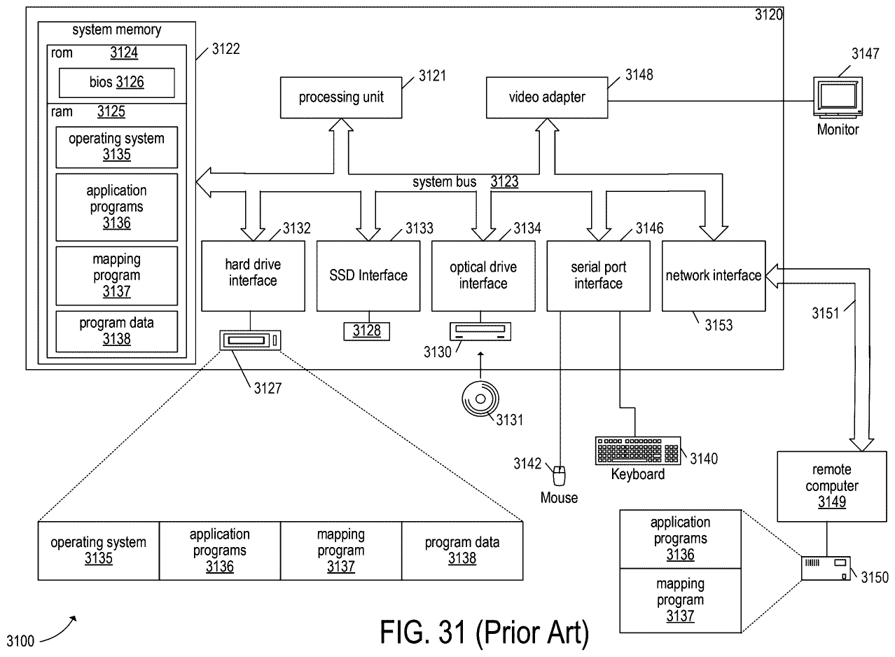

FIG. 30 is a flowchart 3000 illustrating a process for online bidding by a user. Authentication is a process by which an entity, such as a user in a bidding system, proves its identity to the other entities involved in an ecosystem or organization. Aₙ entity, once authenticated, becomes a trusted entity in that ecosystem. Any of various forms of authentication may be deployed, such as password-based login, multi-factor, biometric, certificate-based, and token-based. In the example embodiment, to participate in the online bidding system, a user sends its identification and password (3010) to authenticating server 2740 via user terminal 2710. If the user fails authentication (3015), the user is not permitted to participate in the auction or tender (3035) and the process terminates.

If the user is authenticated, then a UAI is fetched (3020) associated with the auction or tender in which the user wishes to participate. This may be accessed by the user from the bidding process admin directly, or the bidding process admin may supply authorizing parameters to authorizing server 2750 (which may be stored in cloud storage 2780). The user ID and requested UAI are sent (3025) to authorizing server 2750. Authorized users may be included in a list provided, or criteria for authorization may be supplied and compared with attributes of users stored in a database (details not shown). Any authorization procedure to allow and disallow users to participate in auctions or tenders can be utilized. If the user is not authorized (3030), the user is not permitted to participate in the auction or tender (3035) and the process terminates.

There may be different types of bidding processes. One may permit bidding at one time for any user. Another may include survey forms or feedback forms, perhaps to collect information to qualify bidders, and may allow users to return from time to time to fill in the forms, and provide progress metrics, until the bid is complete and submitted. Various metadata can be collected along with the bid, in either encrypted or unencrypted form. Encrypted metadata can be used for additional analysis on encrypted bids. When an authenticated user requests to bid for an auction or tender ID, the authorizing server 2750 verifies the eligibility of the user to cast the bid and if the user is eligible, the public key of the corresponding Auction/Tender ID is dispatched to the user.

Once the user is authenticated and authorized, the bidding process can commence. The user fetches (3040) the public key 2782 associated with the UAI, supplied by authorizing server 2750 as retrieved from the cloud storage 2780. The user accesses the auction or tender page from the bidding process admin directly, or from an auction or tender stored in cloud storage 2780. A response is generated to the auction or tender (3050). The bid is encrypted (3055) with the public key associated with the auction or tender, using an encrypting unit 110. The encrypted bid (3060) is delivered to the validating server 2760. The user may also encrypt its bidder ID (see FIG. 3) and include that along with the encrypted bid. The encrypted bidder ID can be decrypted by the admin 160 for use in identifying the bidder that is associated with a winning bid. Alternatively, a bidder ID can be attached unencrypted.

Returning to FIG. 28, the validation phase occurs when validating server 2760 (part of third-party server 150) receives encrypted bids and generates validated encrypted bids, using methods detailed above, using homomorphic encryption. As detailed previously, cloud storage 2780 holds all the databases and variables for the online voting process such as auction/tender IDs, corresponding public keys and user IDs. In the example embodiment, bids are stored encrypted and there is no mapping of the bids with respective user IDs, except after decrypting in admin 160. In alternate schemes, this decoupling may not be used. For example, if it is desirable to have a user able to verify their bid, encrypted bids may be posted on a public bulletin board, authenticated as coming from their respective bidders.

In the analyzing phase, analysis server 2770 operates on the validated bids to generate the modified bids and winning bids, along with any other analysis requested, in encrypted form, using any of the techniques described above. The analyzed results may also be stored in the cloud storage in encrypted form.

The encrypted results are delivered to admin 160 for the results extraction phase. If one or more analysis clients 2730 are deployed, appropriate analysis/results are delivered in encrypted form to those as well. Using the private key generated previously, the admin 160, and any analysis clients 2730, decrypt the results and the various analyses and bids will be available in cleartext.

FIG. 31 (prior art) depicts a general-purpose computing system 3100 that can serve as a client or a server depending on the program modules and components included. One or more computers of the type depicted in computing system 3100 can be configured to perform operations on devices described with respect to FIGS. 1 and 27, perform the homomorphic operations detailed in FIGS. 4 and 5, and the various flowcharts and processes described herein. Those of skill in the art will appreciate that the invention may be practiced using other system configurations, including hand-held devices, multiprocessor systems, microprocessor-based or programmable consumer electronics, network PCs, minicomputers, mainframe computers, and the like. User terminals 2710, admin 160, analysis client 2730, and third-party server 150 can embody any of these forms, for example.

Computing system 3100 includes a conventional computer 3120, including a processing unit 3121, a system memory 3122, and a system bus 3123 that couples various system components including the system memory to the processing unit 3121. The system bus 3123 may be any of several types of bus structures, including a memory bus or memory controller, a peripheral bus, and a local bus using any of a variety of bus architectures. The system memory includes read only memory (ROM) 3124 and random-access memory (RAM) 3125. A basic input/output system 3126 (BIOS), containing the basic routines that help to transfer information between elements within the computer 3120, such as during start-up, is stored in ROM 3124. The computer 3120 further includes a hard disk drive 3127 for reading from and writing to a hard disk, not shown, a solid-state drive 3128 (e.g. NAND flash memory), and an optical disk drive 3130 for reading from or writing to an optical disk 3131 (e.g., a CD or DVD). The hard disk drive 3127 and optical disk drive 3130 are connected to the system bus 3123 by a hard disk drive interface 3132 and an optical drive interface 3134, respectively. The drives and their associated computer-readable media provide nonvolatile storage of computer readable instructions, data structures, program modules and other data for computer 3120. Other types of computer-readable media can be used.

Program modules are stored on non-transitory, computer-readable media such as disk drive 3127, solid state disk 3128, optical disk 3131, ROM 3124, and RAM 3125. The program modules include an operating system 3135, one or more application programs 3136, other program modules 3137, and program data 3138. An application program 3136 can use other elements that reside in system memory 3122 to perform the processes detailed above.

A user may enter commands and information into the computer 3120 through input devices such as a keyboard 3140 and pointing device 3142. Other input devices (not shown) may include a microphone, joystick, game pad, satellite dish, scanner, or the like. These and other input devices are often connected to the processing unit 3121 through a serial port interface 3146 that is coupled to the system bus, but may be connected by other interfaces, such as a parallel port, game port, universal serial bus (USB), or various wireless options. A monitor 3147 or other type of display device is also connected to the system bus 3123 via an interface, such as a video adapter 3148. In addition to the monitor, computers can include or be connected to other peripheral devices (not shown), such as speakers and printers.

The computer 3120 may operate in a networked environment using logical connections to one or more remote computers, such as a remote computer 3149. The remote computer 3149 may be another computer, a server, a router, a network PC, a peer device, or other common network node, and typically includes many or all the elements described above relative to the computer 3120, although only a memory storage device 3150 has been illustrated in FIG. 31 to show support for e.g., various components of system 2700 noted above in connection with FIG. 27. The logical connections depicted in FIG. 31 include a network connection 3151, which can support a local area network (LAN) and/or a wide area network (WAN). Such networking environments are commonplace in offices, enterprise-wide computer networks, intranets, cellular data systems, and the Internet in general. Network connection 3151 may be used to connect to one or more user terminals 2710 (not shown). Furthermore, network 3151 may connect to any number of distributed systems such as cloud-based storage or other web-based applications.

Computer 3120 includes a network interface 3153 to communicate with remote computer 3149 via network connection 3151. In a networked environment, program modules depicted relative to the computer 3120, or portions thereof, may be stored in the remote memory storage device. It will be appreciated that the network connections shown are exemplary and other means of establishing a communication link between the computers may be used.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

1. A method comprising:
performing, by a processing device, a mathematical operation on an encrypted bid to produce an encrypted result, wherein the mathematical operation applied to the encrypted bid corresponds to an operation that, when applied to plaintext of the encrypted bid, changes the plaintext bid.

2. The method of claim 1, wherein the first-mentioned mathematical operation is a function of an encrypted bid-selection value, the method further comprising performing a second mathematical operation on the encrypted bid and one or more additional encrypted bids to produce the encrypted bid-selection value.

3. The method of claim 2, further comprising performing a third mathematical operation on the encrypted bid to invalidate the encrypted bid when does not conform to a bidding process constraint.

4. The method of claim 3, wherein the bidding process constraint is a reserve price and the third mathematical operation invalidates the encrypted bid when the plaintext of the encrypted bid does not meet the reserve price.

5. The method of claim 1 further comprising:
decrypting the encrypted result; and
comparing the decrypted result with a predetermined value.

6. The method of claim 5, wherein the encrypted bid is associated with a bidder, further comprising identifying the bidder when the decrypted result matches the predetermined value.

7. The method of claim 2, further comprising:
performing the first-mentioned mathematical operation on the one or more additional encrypted bids to produce one or more additional encrypted results;
decrypting the first-mentioned encrypted result and one or more additional results to form a set of decrypted results; and
comparing each of the set of decrypted results with a predetermined value.

8. The method of claim 7, further comprising performing a third mathematical operation on the first-mentioned encrypted result and the one or more additional encrypted results, wherein the third mathematical operation applied to the encrypted result corresponds to an operation that, when applied to plaintext of the encrypted result, changes the value of the plaintext responsive to the plaintext not equaling the predetermined value.

9. The method of claim 8, wherein the third mathematical operation comprises multiplying each of the first-mentioned encrypted result and the one or more additional results by one of a set of non-zero random numbers.

10. The method of claim 8, wherein the third mathematical operation comprises operative steps that, when applied to plaintext of the encrypted result, changes the value of the plaintext to a second predetermined value responsive to the plaintext not equaling the first-mentioned predetermined value.

11. The method of claim 6, wherein each of the first-mentioned encrypted bid and the one or more additional encrypted bids are associated with one of a plurality of bidders, the method further comprising identifying one or more bidders when the decrypted result deriving from the encrypted bid associated with the bidder equals the predetermined value.

12. The method of claim 11, wherein a bidder identification of the bidder is associated with each encrypted bid.

13. The method claim 11, wherein the set of decrypted results have an order, the one or more decrypted results equaling the predetermined values having one or more respective positions in the order, and the one or more bidders are identified by selecting one or more bidder identifications from a list of bidder identifications having the same respective positions in the order.

14. The method of claim 2, wherein the second mathematical function applied to the encrypted bid and the one or more additional encrypted bids results in the encrypted bid-selection value being the maximum of the encrypted bid and the one or more additional encrypted bids.

15. The method of claim 2, wherein the second mathematical function applied to the encrypted bid and the one or more additional encrypted bids results in the encrypted bid-selection value being the minimum of the encrypted bid and the one or more additional encrypted bids.

16. The method of claim 2, further comprising performing a third mathematical operation on the encrypted bid, wherein the third mathematical operation results in the encrypted bid being replaced with the encrypted replacement value responsive to the encrypted bid having a plaintext value of zero.

17. The method of claim 16, wherein the encrypted replacement value is computed as the maximum of the encrypted bid and the one or more additional encrypted bids added to a positive offset value.

18. The method of claim 2, wherein the first mathematical operation comprises subtracting the encrypted bid-selection value from the encrypted bid.

19. The method of claim 2, wherein an encrypted winning bid value is determined as the encrypted bid-selection value.

20. The method of claim 1, wherein the encrypted bid comprises two or more bid values, each of the bid values associated with one of two or more bidding processes, and the mathematical operation corresponds to an operation that, when applied to plaintext of the encrypted bid comprising two or more bid values, changes the plaintext value of each of the two or more bid values.

21. The method of claim 20, wherein the first-mentioned mathematical operation is a function of two or more encrypted bid-selection values, each encrypted bid-selection value associated with one of the two or more bidding processes, the method further comprising performing a second mathematical operation on the encrypted bid and one or more additional encrypted bids to produce the two or more encrypted bid-selection values.

22. The method of claim 21, further comprising:
performing the first-mentioned mathematical operation on the one or more additional encrypted bids to produce one or more additional encrypted results;
decrypting the first-mentioned encrypted result and one or more additional results to form a set of decrypted results; and
comparing each changed two or more bid values in each of the set of decrypted results with a predetermined value.

23. The method of claim 22, further comprising performing a third mathematical operation on the first-mentioned encrypted result and the one or more additional encrypted results, the third mathematical operation changing each of the two or more bid values in each encrypted result for which its decrypted plaintext value does not equal the predetermined value.

24. A method, performed by a processing device, for maintaining confidentiality of bid values in an online bidding process, comprising:
receiving a plurality of encrypted bids, each encrypted bid encrypting an associated plaintext bid value using a homomorphic encryption scheme;
determining an encrypted winning bid value from the plurality of encrypted bids;
performing a first mathematical operation on each of the plurality of encrypted bids to produce a plurality of encrypted results, wherein the first mathematical operation applied to the encrypted bid corresponds to an operation that, when applied to its associated plaintext bid, responsive to the associated plaintext bid equaling the winning bid value, changes the associated plaintext bid to a predetermined value and, otherwise, changes the associated plaintext bid to a value distinct from the predetermined value;
performing a second mathematical operation on each of the plurality of encrypted results, wherein the second mathematical operation applied to the encrypted result corresponds to an operation that, when applied to its associated plaintext, responsive to the associated plaintext not equaling the predetermined value, changes the associated plaintext.

25. The method of claim 24, wherein the second mathematical operation prevents determination of the original bid values, other than the winning bid value, upon decryption of the plaintext of the plurality of encrypted results.

26. The method of claim 24, wherein the second mathematical operation prevents the determination of a difference two or more original bid values upon decryption of and comparison between the plaintext of two or more of the plurality of encrypted results.

27. The method of claim 24, further comprising validating each encrypted bid according to predetermined criteria prior to determining the encrypted winning bid value.

28. The method of claim 27, wherein the predetermined criteria comprise reserve price constraints.

29. The method of claim 27, wherein the predetermined criteria comprise positive bid value constraints.

30. The method of claim 24, wherein each encrypted bid comprises a first bid value for a first bidding event and one or or more second bid values for one or more second bidding events.

31. The method of claim 30, wherein determining the encrypted winning bid value comprises homomorphically selecting a respective bidding-event winning bid value for each of the first and one or more second bidding events.

32. The method of claim 31, wherein the first mathematical operation utilizes the respective bidding-event winning bid values to operate on the encrypted bids such that a corresponding operation on the plaintext first and one or more second bid values utilize a respective bidding-event predetermined value for changing each first or second bid value corresponding to each of the respective first or second bidding events.

33. The method of claim 32, wherein second mathematical operation operates on the plurality of encrypted results to change the associated plaintext values for each of the bidding events in an encrypted result independently.

34. The method of claim 24, further comprising transmitting encrypted bidding process results to a decryption entity for extraction of the winning bid and bidder.

35. The method of claim 34, wherein the encrypted bidding process results comprise the plurality of encrypted results of the second mathematical operation and the winning bid.

36. The method of claim 34, wherein:
the second mathematical operation comprises operative steps that, when applied to plaintext of the encrypted result, changes the value of the plaintext to a second predetermined value responsive to the plaintext not equaling the first-mentioned predetermined value; and
the encrypted bidding process results comprise the plurality of encrypted results of the second mathematical operation.

37. The method of claim 34, further comprising:
validating each encrypted bid according to predetermined criteria prior to determining the encrypted winning bid value; and
generating a plurality of modified bids using the plurality of validated encrypted bids and the plurality of encrypted results of the second mathematical operation; and
wherein the encrypted bidding process results comprise the plurality of encrypted results of the second mathematical operation and the plurality of modified bids.

38. The method of claim 34, wherein extraction of the encrypted bidding process results prevents revealing the original bid values, other than the winning bid, and the difference between two or more original bid values.

39. The method of claim 24, wherein the second mathematical operation comprises multiplying each of the encrypted results by one of a set of uncorrelated non-zero random numbers.

40. A computation device, comprising:
a receiver for receiving a plurality of encrypted bids;
a processor for performing a mathematical operation on each of the plurality of encrypted bid to produce an encrypted result, wherein the mathematical operation applied to the encrypted bid corresponds to an operation that, when applied to plaintext of the encrypted bid, changes the plaintext bid; and
a transmitter for transmitting the encrypted bids to a second computation device.

41-49. (canceled)
